(19) United States
(12) Patent Application Publication
(10) Pub. No.: US 2023/0345454 A1
(43) Pub. Date: Oct. 26, 2023

(54) TECHNIQUES FOR SENDING A COLLISION INDICATION VIA A PHYSICAL SIDELINK FEEDBACK CHANNEL

(71) Applicant: QUALCOMM Incorporated, San Diego, CA (US)

(72) Inventors: Tien Viet Nguyen, Bridgewater, NJ (US); Gabi Sarkis, San Diego, CA (US); Shuanshuan Wu, San Diego, CA (US); Kapil Gulati, Belle Mead, NJ (US)

(21) Appl. No.: 17/727,195

(22) Filed: Apr. 22, 2022

(51) Int. Cl. H04W 72/12; H04W 28/26; H04W 24/10; H04W 72/04

(52) U.S. Cl. CPC H04W 72/1263; H04W 28/26; H04W 24/10; H04W 72/1278; H04W 72/0446; H04W 72/0406

(57) ABSTRACT

Methods, systems, and devices for wireless communications are described. User equipments (UEs) may transmit sidelink control information (SCI) messages indicating reservations for upcoming sidelink transmissions in the same reserved resource. One of the UEs or another UE may detect a collision in the reserved resource based on the SCI messages. A feedback channel resource for indicating the collision may be calculated based on a time domain parameter of a resource mapping between time domain resources of the sidelink feedback channel and time domain resources of the reserved resource or a frequency domain parameter of a resource mapping between frequency domain resources of the sidelink feedback channel and frequency domain resources of the SCI message. A UE may transmit a collision indication in the calculated feedback channel resource. The UEs that transmitted the SCI messages may monitor the calculated feedback channel resource for a collision indication for the reserved resource.

### FIELD OF TECHNOLOGY

The following relates to wireless communications, including techniques for sending a collision indication via a physical sidelink feedback channel.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support techniques for sending a collision indication via a physical sidelink feedback channel (PSFCH). For example, the described techniques provide for indicating the location of the feedback channel resource (e.g., the PSFCH resource) for a collision indication for a resource reservation. Two or more user equipments (UEs) may transmit sidelink control information (SCI) messages indicating reservations for upcoming sidelink transmissions in the same or at least partially overlapping reserved resource (e.g., the same physical sidelink shared channel (PSSCH) resource). One of the UEs or another UE (e.g., a bystander UE) may detect a collision in the reserved resource based on the SCI messages. In some examples, a feedback channel resource for indicating the collision may be calculated based on a time domain parameter of a resource mapping between time domain resources of the sidelink feedback channel and time domain resources of the reserved resource. In some examples, a feedback channel resource for indicating the collision may be calculated based on a frequency domain parameter of a resource mapping between frequency domain resources of the sidelink feedback channel and frequency domain resources of the SCI message. If a UE identifies a collision, the UE may transmit a collision indication in the calculated feedback channel resource. The UEs that transmitted the SCI messages may monitor the calculated feedback channel resource for a collision indication for the reserved resource. The UEs may communicate the sidelink channel transmission(s) based on monitoring the calculated feedback channel resource for a collision indication. For example, if the feedback channel resource indicates a collision, a UE that receives the feedback may transmit the sidelink transmission on a different resource.

A method for wireless communications at a user equipment (UE) is described. The method may include transmitting a SCI message indicating a reserved resource for an upcoming sidelink transmission, calculating a sidelink feedback channel resource of a sidelink feedback channel for a collision indication for the reserved resource based on a time domain parameter of a resource mapping between time domain resources of the sidelink feedback channel and time domain resources of the reserved resource, and monitoring the sidelink feedback channel resource for the collision indication.

An apparatus for wireless communications at a UE is described. The apparatus may include a processor, memory coupled with the processor, and instructions stored in the memory. The instructions may be executable by the processor to cause the apparatus to transmit a SCI message indicating a reserved resource for an upcoming sidelink transmission, calculate a sidelink feedback channel resource of a sidelink feedback channel for a collision indication for the reserved resource based on a time domain parameter of a resource mapping between time domain resources of the sidelink feedback channel and time domain resources of the reserved resource, and monitor the sidelink feedback channel resource for the collision indication.

Another apparatus for wireless communications at a UE is described. The apparatus may include means for transmitting a SCI message indicating a reserved resource for an upcoming sidelink transmission, means for calculating a sidelink feedback channel resource of a sidelink feedback channel for a collision indication for the reserved resource based on a time domain parameter of a resource mapping between time domain resources of the sidelink feedback channel and time domain resources of the reserved resource, and means for monitoring the sidelink feedback channel resource for the collision indication.

A non-transitory computer-readable medium storing code for wireless communications at a UE is described. The code may include instructions executable by a processor to transmit a SCI message indicating a reserved resource for an upcoming sidelink transmission, calculate a sidelink feedback channel resource of a sidelink feedback channel for a collision indication for the reserved resource based on a time domain parameter of a resource mapping between time domain resources of the sidelink feedback channel and time domain resources of the reserved resource, and monitor the sidelink feedback channel resource for the collision indication.

In some examples of the method, apparatuses, and non-transitory computer-readable medium described herein, calculating the sidelink feedback channel resource may include operations, features, means, or instructions for calculating the sidelink feedback channel resource based on a time domain resource indexing scheme of the resource mapping, where the time domain resource indexing scheme begins at a first time domain resource corresponding to the sidelink feedback channel resource and increments up to a second time domain resource corresponding to the reserved resource.

In some examples of the method, apparatuses, and non-transitory computer-readable medium described herein, calculating the sidelink feedback channel resource may include operations, features, means, or instructions for calculating the sidelink feedback channel resource based on a time domain resource indexing scheme of the resource mapping, where the time domain resource indexing scheme begins at a first time domain resource corresponding to the reserved resource and increments up to a second time domain resource corresponding to the sidelink feedback channel resource.

In some examples of the method, apparatuses, and non-transitory computer-readable medium described herein, calculating the sidelink feedback channel resource may include operations, features, means, or instructions for calculating the sidelink feedback channel resource based on a frequency domain parameter of a second resource mapping between frequency domain resources of the sidelink feedback channel and frequency domain resources of the SCI message.

In some examples of the method, apparatuses, and non-transitory computer-readable medium described herein, calculating the sidelink feedback channel resource may include operations, features, means, or instructions for calculating a resource block index, where the sidelink feedback channel resource includes a resource block associated with the resource block index.

Some examples of the method, apparatuses, and non-transitory computer-readable medium described herein may further include operations, features, means, or instructions for receiving an indication of the collision indication in the sidelink feedback channel resource and transmitting the upcoming sidelink transmission using a communications resource different from the reserved resource based on the collision indication.

Some examples of the method, apparatuses, and non-transitory computer-readable medium described herein may further include operations, features, means, or instructions for transmitting the upcoming sidelink transmission using the reserved resource based on the monitoring the sidelink feedback channel resource.

In some examples of the method, apparatuses, and non-transitory computer-readable medium described herein, calculating the sidelink feedback channel resource may include operations, features, means, or instructions for calculating a first slot, where the sidelink feedback channel resource includes the first slot and the reserved resource includes a second slot.

In some examples of the method, apparatuses, and non-transitory computer-readable medium described herein, the first slot precedes the second slot.

In some examples of the method, apparatuses, and non-transitory computer-readable medium described herein, the sidelink feedback channel resource includes a PSFCH.

A method for wireless communications at a first UE is described. The method may include receiving, from a second UE, a SCI message indicating a reserved resource for a first upcoming sidelink transmission, identifying a collision in the reserved resource, calculating a sidelink feedback channel resource of a sidelink feedback channel for a collision indication for the reserved resource based on a time domain parameter of a resource mapping between time domain resources of the sidelink feedback channel and time domain resources of the reserved resource, and transmitting the collision indication in the sidelink feedback channel resource.

An apparatus for wireless communications at a first UE is described. The apparatus may include a processor, memory coupled with the processor, and instructions stored in the memory. The instructions may be executable by the processor to cause the apparatus to receive, from a second UE, a SCI message indicating a reserved resource for a first upcoming sidelink transmission, identify a collision in the reserved resource, calculate a sidelink feedback channel resource of a sidelink feedback channel for a collision indication for the reserved resource based on a time domain parameter of a resource mapping between time domain resources of the sidelink feedback channel and time domain resources of the reserved resource, and transmit the collision indication in the sidelink feedback channel resource.

Another apparatus for wireless communications at a first UE is described. The apparatus may include means for receiving, from a second UE, a SCI message indicating a reserved resource for a first upcoming sidelink transmission, means for identifying a collision in the reserved resource, means for calculating a sidelink feedback channel resource of a sidelink feedback channel for a collision indication for the reserved resource based on a time domain parameter of a resource mapping between time domain resources of the sidelink feedback channel and time domain resources of the reserved resource, and means for transmitting the collision indication in the sidelink feedback channel resource.

A non-transitory computer-readable medium storing code for wireless communications at a first UE is described. The code may include instructions executable by a processor to receive, from a second UE, a SCI message indicating a reserved resource for a first upcoming sidelink transmission, identify a collision in the reserved resource, calculate a sidelink feedback channel resource of a sidelink feedback channel for a collision indication for the reserved resource based on a time domain parameter of a resource mapping between time domain resources of the sidelink feedback channel and time domain resources of the reserved resource, and transmit the collision indication in the sidelink feedback channel resource.

In some examples of the method, apparatuses, and non-transitory computer-readable medium described herein, calculating the sidelink feedback channel resource may include operations, features, means, or instructions for calculating the sidelink feedback channel resource based on a time domain resource indexing scheme of the resource mapping, where the time domain resource indexing scheme begins at a first time domain resource corresponding to the sidelink feedback channel resource and increments up to a second time domain resource corresponding to the reserved resource.

In some examples of the method, apparatuses, and non-transitory computer-readable medium described herein, calculating the sidelink feedback channel resource may include operations, features, means, or instructions for calculating the sidelink feedback channel resource based on a time domain resource indexing scheme of the resource mapping, where the time domain resource indexing scheme begins at a first time domain resource corresponding to the reserved resource and increments up to a second time domain resource corresponding to the sidelink feedback channel resource.

In some examples of the method, apparatuses, and non-transitory computer-readable medium described herein, calculating the sidelink feedback channel resource may include operations, features, means, or instructions for calculating the sidelink feedback channel resource based on a frequency domain parameter of a second resource mapping between frequency domain resources of the sidelink feedback channel and frequency domain resources of the SCI message.

In some examples of the method, apparatuses, and non-transitory computer-readable medium described herein, calculating the sidelink feedback channel resource may include operations, features, means, or instructions for calculating a resource block index, where the sidelink feedback channel resource includes a resource block associated with the resource block index.

In some examples of the method, apparatuses, and non-transitory computer-readable medium described herein, calculating the sidelink feedback channel resource may include operations, features, means, or instructions for calculating a first slot, where the sidelink feedback channel resource includes the first slot and the reserved resource includes a second slot.

In some examples of the method, apparatuses, and non-transitory computer-readable medium described herein, the first slot precedes the second slot.

In some examples of the method, apparatuses, and non-transitory computer-readable medium described herein, the sidelink feedback channel resource includes a PSFCH.

Some examples of the method, apparatuses, and non-transitory computer-readable medium described herein may further include operations, features, means, or instructions for receiving, from a third UE, a second SCI message indicating the reserved resource for a second upcoming sidelink transmission, where the identifying the collision in the reserved resource may be based on the SCI message and the second SCI message.

A method for wireless communications at a UE is described. The method may include transmitting a SCI message indicating a reserved resource for an upcoming sidelink transmission, calculating a sidelink feedback channel resource of a sidelink feedback channel for a collision indication for the reserved resource based on a frequency domain parameter of a resource mapping between frequency domain resources of the sidelink feedback channel and frequency domain resources of the SCI message, and monitoring the sidelink feedback channel resource for the collision indication.

An apparatus for wireless communications at a UE is described. The apparatus may include a processor, memory coupled with the processor, and instructions stored in the memory. The instructions may be executable by the processor to cause the apparatus to transmit a SCI message indicating a reserved resource for an upcoming sidelink transmission, calculate a sidelink feedback channel resource of a sidelink feedback channel for a collision indication for the reserved resource based on a frequency domain parameter of a resource mapping between frequency domain resources of the sidelink feedback channel and frequency domain resources of the SCI message, and monitor the sidelink feedback channel resource for the collision indication.

Another apparatus for wireless communications at a UE is described. The apparatus may include means for transmitting a SCI message indicating a reserved resource for an upcoming sidelink transmission, means for calculating a sidelink feedback channel resource of a sidelink feedback channel for a collision indication for the reserved resource based on a frequency domain parameter of a resource mapping between frequency domain resources of the sidelink feedback channel and frequency domain resources of the SCI message, and means for monitoring the sidelink feedback channel resource for the collision indication.

A non-transitory computer-readable medium storing code for wireless communications at a UE is described. The code may include instructions executable by a processor to transmit a SCI message indicating a reserved resource for an upcoming sidelink transmission, calculate a sidelink feedback channel resource of a sidelink feedback channel for a collision indication for the reserved resource based on a frequency domain parameter of a resource mapping between frequency domain resources of the sidelink feedback channel and frequency domain resources of the SCI message, and monitor the sidelink feedback channel resource for the collision indication.

In some examples of the method, apparatuses, and non-transitory computer-readable medium described herein, calculating the sidelink feedback channel resource may include operations, features, means, or instructions for calculating a resource block index, where the sidelink feedback channel resource includes a resource block associated with the resource block index.

In some examples of the method, apparatuses, and non-transitory computer-readable medium described herein, the SCI message includes the resource block.

In some examples of the method, apparatuses, and non-transitory computer-readable medium described herein, calculating the sidelink feedback channel resource may include operations, features, means, or instructions for calculating the sidelink feedback channel resource based on a time domain parameter of a second resource mapping between time domain resources of the sidelink feedback channel and time domain resources of the reserved resource.

Some examples of the method, apparatuses, and non-transitory computer-readable medium described herein may further include operations, features, means, or instructions for receiving an indication of the collision indication in the sidelink feedback channel resource and transmitting the upcoming sidelink transmission using a communications resource different from the reserved resource based on the collision indication.

Some examples of the method, apparatuses, and non-transitory computer-readable medium described herein may further include operations, features, means, or instructions for transmitting the upcoming sidelink transmission using the reserved resource based on the monitoring the sidelink feedback channel resource.

A method for wireless communications at a first UE is described. The method may include receiving, from a second UE, a SCI message indicating a reserved resource for a first upcoming sidelink transmission, identifying a collision in the reserved resource, calculating a sidelink feedback channel resource of a sidelink feedback channel for a collision indication for the reserved resource based on a frequency domain parameter of a resource mapping between frequency domain resources of the sidelink feedback channel and frequency domain resources of the SCI message, and transmitting the collision indication in the sidelink feedback channel resource.

An apparatus for wireless communications at a first UE is described. The apparatus may include a processor, memory coupled with the processor, and instructions stored in the memory. The instructions may be executable by the processor to cause the apparatus to receive, from a second UE, a SCI message indicating a reserved resource for a first upcoming sidelink transmission, identify a collision in the reserved resource, calculate a sidelink feedback channel resource of a sidelink feedback channel for a collision indication for the reserved resource based on a frequency domain parameter of a resource mapping between frequency domain resources of the sidelink feedback channel and frequency domain resources of the SCI message, and transmit the collision indication in the sidelink feedback channel resource.

Another apparatus for wireless communications at a first UE is described. The apparatus may include means for receiving, from a second UE, a SCI message indicating a reserved resource for a first upcoming sidelink transmission, means for identifying a collision in the reserved resource, means for calculating a sidelink feedback channel resource of a sidelink feedback channel for a collision indication for the reserved resource based on a frequency domain parameter of a resource mapping between frequency domain resources of the sidelink feedback channel and frequency domain resources of the SCI message, and means for transmitting the collision indication in the sidelink feedback channel resource.

A non-transitory computer-readable medium storing code for wireless communications at a first UE is described. The code may include instructions executable by a processor to receive, from a second UE, a SCI message indicating a reserved resource for a first upcoming sidelink transmission, identify a collision in the reserved resource, calculate a sidelink feedback channel resource of a sidelink feedback channel for a collision indication for the reserved resource based on a frequency domain parameter of a resource mapping between frequency domain resources of the sidelink feedback channel and frequency domain resources of the SCI message, and transmit the collision indication in the sidelink feedback channel resource.

In some examples of the method, apparatuses, and non-transitory computer-readable medium described herein, calculating the sidelink feedback channel resource may include operations, features, means, or instructions for calculating a resource block index, where the sidelink feedback channel resource includes a resource block associated with the resource block index.

In some examples of the method, apparatuses, and non-transitory computer-readable medium described herein, the SCI message includes the resource block.

In some examples of the method, apparatuses, and non-transitory computer-readable medium described herein, calculating the sidelink feedback channel resource may include operations, features, means, or instructions for calculating the sidelink feedback channel resource based on a time domain parameter of a second resource mapping between time domain resources of the sidelink feedback channel and time domain resources of the reserved resource.

Some examples of the method, apparatuses, and non-transitory computer-readable medium described herein may further include operations, features, means, or instructions for receiving, from a third UE, a second SCI message indicating the reserved resource for a second upcoming sidelink transmission, where the identifying the collision in the reserved resource may be based on the SCI message and the second SCI message.

### BRIEF DESCRIPTION OF THE DRAWINGS

FIG. 1 illustrates an example of a wireless communications system that supports techniques for sending a collision indication via a physical sidelink feedback channel (PSFCH) in accordance with one or more aspects of the present disclosure.

FIG. 2 illustrates an example of a wireless communications system that supports techniques for sending a collision indication via a PSFCH in accordance with one or more aspects of the present disclosure.

FIG. 3 illustrates an example of a resource diagram that supports techniques for sending a collision indication via a PSFCH in accordance with one or more aspects of the present disclosure.

FIG. 4 illustrates an example of a timing diagram that supports techniques for sending a collision indication via a PSFCH in accordance with one or more aspects of the present disclosure.

FIG. 5 illustrates an example of a resource diagram that supports techniques for sending a collision indication via a PSFCH in accordance with one or more aspects of the present disclosure.

FIG. 6 illustrates an example of a process flow that supports techniques for sending a collision indication via a PSFCH in accordance with one or more aspects of the present disclosure.

FIGS. 7 and 8 show block diagrams of devices that support techniques for sending a collision indication via a PSFCH in accordance with one or more aspects of the present disclosure.

FIG. 9 shows a block diagram of a communications manager that supports techniques for sending a collision indication via a PSFCH in accordance with one or more aspects of the present disclosure.

FIG. 10 shows a diagram of a system including a device that supports techniques for sending a collision indication via a PSFCH in accordance with one or more aspects of the present disclosure.

FIGS. 11 through 18 show flowcharts illustrating methods that support techniques for sending a collision indication via a PSFCH in accordance with one or more aspects of the present disclosure.

### DETAILED DESCRIPTION

Some wireless communications systems may support sidelink communications between user equipment (UEs). In such systems, the UEs may exchange data and control information over data channels (e.g., physical sidelink shared channels (PSSCHs)) and control channels (e.g., physical sidelink control channels (PSCCHs)), and the UEs may exchange feedback over feedback channels (e.g., physical sidelink feedback channels (PSFCHs)). The feedback may include acknowledgment (ACK) or negative ACK (NACK) feedback indicating whether a UE successfully received sidelink data from another UE, or the feedback may include collision indications (e.g., or other inter-UE coordination information) that each indicate whether a resource reservation by one UE overlaps or collides with a resource reservation by another UE. In some cases, the location (e.g., time and frequency resources) of the feedback channel resource for a collision indication for a resource reservation may be based on the location (e.g., time and frequency resources) of the sidelink control information (SCI) that indicated the conflicting resources. In such cases, the UEs transmitting the SCIs would monitor for collision indications, and bystander UEs would transmit collision indications, in feedback channel resources based on the location of the SCIs. However, in some cases, the location of the feedback channel resource for a collision indication may be based on the location of the conflicting or colliding resources. In such cases, techniques for calculating and indicating the location of the feedback channel resource for a collision indication may be undefined where the feedback channel resource is based on the resources of the conflicting resources (rather than being based on the resources of the SCI that indicated the conflicting resources).

Aspects of the disclosure relate to techniques for indicating the location of the feedback channel resource for a collision indication for a resource reservation. Two or more UEs may transmit SCI messages indicating reservations for upcoming sidelink transmissions in the same or at least partially overlapping reserved resource (e.g., the same PSSCH resource). One of the UEs or another UE (e.g., a bystander UE) may detect a collision in the reserved resource based on the SCI messages. In some examples, a feedback channel resource (e.g., a PSFCH resource) for indicating the collision may be calculated based on a time domain parameter of a resource mapping between time domain resources of the sidelink feedback channel and time domain resources of the reserved resource. In addition to or as an alternative to the time domain resource mapping, in some examples, a feedback channel resource for indicating the collision may be calculated based on a frequency domain parameter of a resource mapping between frequency domain resources of the sidelink feedback channel and frequency domain resources of the SCI message. If a UE identifies a collision, the UE may transmit a collision indication in the calculated feedback channel resource. The UEs that transmitted the SCI messages may monitor the calculated feedback channel resource for a collision indication for the reserved resource. The UEs may communicate the sidelink channel transmission(s) based on monitoring the calculated feedback channel resource for a collision indication. For example, if the feedback channel resource indicates a collision, a UE that receives the feedback may transmit the sidelink transmission on a different resource.

In some examples, the resource mapping for the feedback channel resource may be based on a time domain resource indexing scheme. For example, the feedback channel resource may be a defined number of indices of time domain resources (e.g., slots) away from the reserved resource. In some cases, the time domain resource indexing scheme may begin at a first time domain resource corresponding to the sidelink feedback channel resource and increments up to a second time domain resource corresponding to the reserved resource. In some cases, the time domain resource indexing scheme begins at a first time domain resource corresponding to the reserved resource and increments up to a second time domain resource corresponding to the sidelink feedback channel resource.

In some examples, a frequency domain parameter of the sidelink feedback channel resource may be calculated, for example, based on the frequency resource (e.g., a subchannel) of the SCI messages. For example, the frequency domain parameter of the sidelink feedback channel may be based on (e.g., the same as) the later received SCI message. Accordingly, a UE may determine to monitor for a collision indication for a reserved resource in the same frequency resource that the UE transmitted an SCI message reserving the reserved resource.

Aspects of the disclosure are initially described in the context of wireless communications systems. Aspects of the disclosure are further illustrated by and described with reference to resource diagrams, timing diagrams, and process flows. Aspects of the disclosure are further illustrated by and described with reference to apparatus diagrams, system diagrams, and flowcharts that relate to techniques for sending a collision indication via a PSFCH.

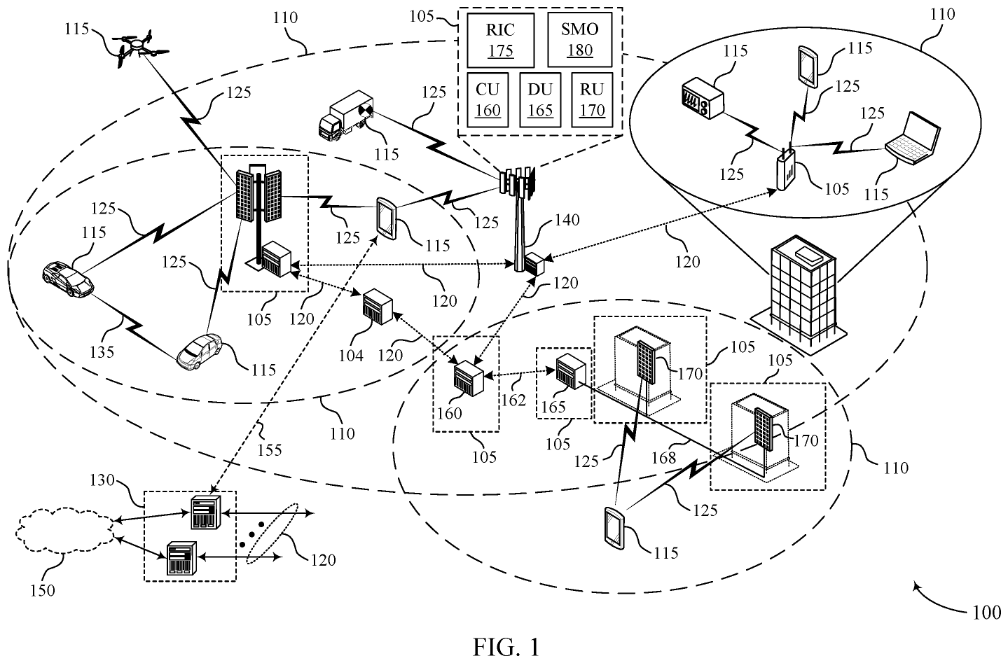

FIG. 1 illustrates an example of a wireless communications system 100 that supports techniques for sending a collision indication via a PSFCH in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support techniques for sending a collision indication via a PSFCH as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ, N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

Two or more UEs 115 may transmit SCI messages indicating reservations for upcoming sidelink transmissions in the same or at least partially overlapping reserved resource (e.g., the same PSSCH resource). One of the UEs 115 or another UE 115 (e.g., a bystander UE) may detect a collision in the reserved resource based on the SCI messages. In some examples, a feedback channel resource (e.g., a PSFCH resource) for indicating the collision may be calculated based on a time domain parameter of a resource mapping between time domain resources of the sidelink feedback channel and time domain resources of the reserved resource. In some examples, a feedback channel resource for indicating the collision may be calculated based on a frequency domain parameter of a resource mapping between frequency domain resources of the sidelink feedback channel and frequency domain resources of the SCI message. If a UE 115 identifies a collision, the UE 115 may transmit a collision indication in the calculated feedback channel resource. The UEs 115 that transmitted the SCI messages may monitor the calculated feedback channel resource for a collision indication for the reserved resource. The UEs 115 may communicate the sidelink channel transmission(s) based on monitoring the calculated feedback channel resource for a collision indication. For example, if the feedback channel resource indicates a collision, a UE 115 that receives the feedback may transmit the sidelink transmission on a different resource.

In some examples, the resource mapping for the feedback channel resource may be based on a time domain resource indexing scheme. For example, the feedback channel resource may be a defined number of indices of time domain resources (e.g., slots) away from the reserved resource. In some cases, the time domain resource indexing scheme may begin at a first time domain resource corresponding to the sidelink feedback channel resource and increments up to a second time domain resource corresponding to the reserved resource. In some cases, the time domain resource indexing scheme begins at a first time domain resource corresponding to the reserved resource and increments up to a second time domain resource corresponding to the sidelink feedback channel resource.

In some examples, a frequency domain parameter of the sidelink feedback channel resource may be calculated, for example, based on the frequency resource (e.g., a subchannel or set of subchannels) of the SCI messages. For example, the frequency domain parameter of the sidelink feedback channel may be based on (e.g., the same as) the later received SCI message. Accordingly, a UE 115 may determine to monitor for a collision indication for a reserved resource in the same frequency resource that the UE 115 transmitted an SCI message reserving the reserved resource.

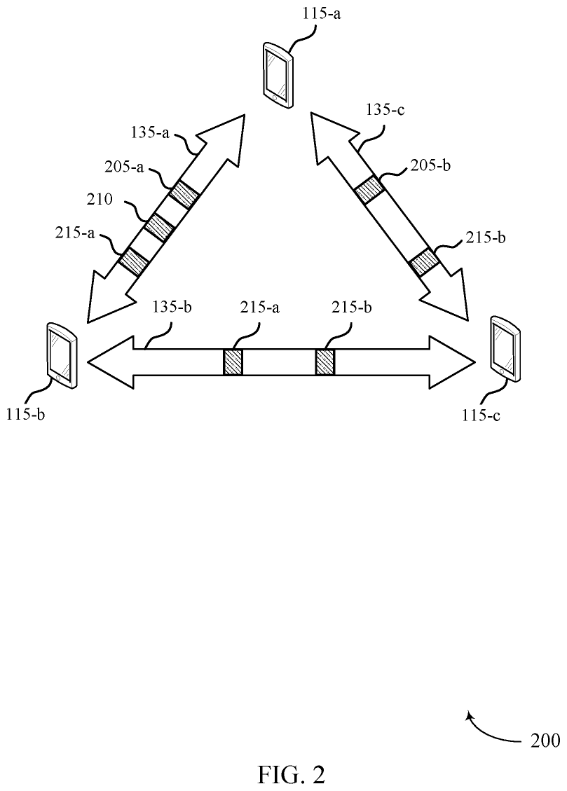

FIG. 2 illustrates an example of a wireless communications system 200 that supports techniques for sending a collision indication via a PSFCH in accordance with one or more aspects of the present disclosure. The wireless communications system 200 may include a first UE 115-a, a second UE 115-b, and a third UE 115-c, which may be examples of a UE 115 as described herein.

The first UE 115-a may communicate with the second UE 115-b using a sidelink communication link 135-a. The second UE 115-b may communicate with the third UE 115-c using a sidelink communication link 135-b. The first UE 115-a may communicate with the third UE 115-c using a sidelink communication link 135-c. The sidelink communication link 135-a, the sidelink communication link 135-b, and the sidelink communication link 135-c may include bi-directional links that enable the UEs 115 to transmit and receive sidelink signals. In some examples (e.g., in Mode 1), the network (e.g., a serving network entity 105) may configure resources for the sidelink communication link 135-a, the sidelink communication link 135-b, and/or the sidelink communication link 135-c. In some examples, the UEs 115 may communicate over the sidelink communication links 135 using directional communications techniques (e.g., beamforming techniques). In some examples (e.g., in Mode 2), the first UE 115-a, the second UE 115-b, and/or the third UE 115-c may determine and configure the resources for the sidelink communication links 135 autonomously (e.g., without involvement from a serving network entity 105).

In Mode 2, the UEs 115 may be configured to support inter-UE coordination schemes. For example, in a first inter-UE coordination scheme, coordination information sent from a first UE 115-a to a second UE 115-b may include a set of resources that are preferred and/or not preferred for transmission by the second UE 115-b. In a second inter-UE coordination scheme, coordination information sent from a first UE 115-a to a second UE 115-b may include the presence, expected presence, and/or a detected conflict on resources indicated by an SCI message 205-a transmitted by the second UE 115-b.

For example, the second UE 115-b may transmit an SCI message 205-a reserving a resource for a sidelink transmission 215-a. The sidelink transmission 215-a may be intended for the first UE 115-a, the third UE 115-c, or another UE 115. The third UE 115-c may also transmit an SCI message 205-b reserving a resource for a sidelink transmission 215-b. The sidelink transmission 215-b may be intended for the first UE 115-a, the second UE 115-b, or another UE 115. The second UE 115-b may transmit the SCI message 205-a after the third UE 115-c transmits the SCI message 205-b.

The first UE 115-a may monitor for SCI messages 205 from the second UE 115-b and the third UE 115-c. The first UE 115-a may identify a collision if both the SCI message 205-a and the SCI message 205-b reserve the same or a partially overlapping resource for the sidelink transmission 215-a and the sidelink transmission 215-b. In some cases, the first UE 115-a may be the target of the sidelink transmission 215-a. In some cases, the first UE 115-a may not be the target of the sidelink transmission 215-a (e.g., the first UE 115-a may be a bystander UE). Whether a bystander UE 115 monitors for collisions between sidelink transmissions 215 may be preconfigured. In some examples, the first UE 115-a may determine a collision occurs on the resources reserved by the SCI message 205-a if reserved resources of another UE (e.g., third UE 115-c) are fully or partially overlapping with the resources reserved by the SCI message 205-a in time and frequency. In some examples, the first UE 115-a may determine a collision occurs on the resources reserved by the SCI message 205-a if the first UE 115-a is the intended recipient of the sidelink transmission 215-a and the first UE 115-a does not expect to receive a sidelink transmission in the resources reserved by the SCI message 205-a based on a half-duplex operation.

If the first UE 115-a identifies a collision, the first UE 115-a may transmit a collision indication 210 via a PSFCH resource. In some cases, the PSFCH format 0 may be used to convey the collision indication 210. The first UE 115-a may monitor the PSFCH resource for a collision indication 210. If the second UE 115-b does not receive a collision indication 210 on the expected PSFCH resource, the second UE 115-b may transmit the sidelink transmission 215-a using the resource reserved in the SCI message 205-a. If the second UE 115-b receives a collision indication 210 on the expected PSFCH resource, the second UE 115-b may transmit the sidelink transmission 215-a using a different resource from the resource reserved in the SCI message 205-a.

Accordingly, the second UE 115-b may determine which PSFCH resource to monitor for the collision indication 210. The set of physical resource blocks (PRBs) for PSFCH transmission and reception may be configured separately from PRBs for sidelink HARQ feedback. In some cases, the mapping of the reserved resource for a sidelink transmission 215-a to a collision indication 210 may be based on the location of the SCI message 205-a reserving the resource. For example, the timing between a PSSCH and a PSFCH may be used to determine the PSFCH occasion to use for a collision indication 210. The time gap between the PSFCH occasion and the reserved resource for the sidelink transmission 215-a may be larger than a configured threshold time T3.

In some cases, the mapping of the reserved resource for a sidelink transmission 215-a to a collision indication 210 may be based on the location of the reserved resource. For example, the first UE 115-a may transmit the PSFCH in a latest slot that includes PSFCH for inter-UE coordination information and is located in a slot at least T3 before the reserved resource. The index of a PSFCH resource for inter-UE coordination information transmissions may be determined similarly to the index of a PSFCH for HARQ feedback, but with the physical layer source identifier (P_{ID}) indicated by the SCI message 205-a and the identity of the receiving UE (M_{ID}) set to “0”. For a collision indication 210, the values of the period of PSFCH resources, the number of cyclic shift pairs used for a PSFCH transmission that may be multiplexed in a PRB, and the number of PSFCH resources available for multiplexing information in a PSFCH transmission may be the same as those for sidelink HARQ feedback in the same resource pool. A value for computing a cyclic shift (m_{CS}) for a collision indication 210 for a next reserved resource indicated by the SCI message 205-a for either the current transport block transmission or the next transport block transmission may be set to “0”.

A same formula may be used to derive a resource index for the PSFCH resource for a collision indication 210 as for HARQ feedback. A UE 115 (e.g., the first UE 115-a and/or the second UE 115-b) may be provided, by the parameter sl-PSFCH-RB-Set, a set of M_{PRB, set}^{PSFCH} PRBs in a resource pool for PSFCH transmission with HARQ-ACK information in a PRB of the resource pool. A UE 115 (e.g., the first UE 115-a and/or the second UE 115-b) may be provided, by the parameter sl-PSFCH-Conflict-RB-Set, a set of M_{PRB, set}^{PSFCH} PRBs in a resource pool for PSFCH transmission with conflict information (e.g., a collision indication 210) in a PRB of the resource pool. For a number of N_{subch} sub-channels for the resource pool, provided by the parameter sl-NumSubchannel, and a number of PSSCH slots associated with a PSFCH slot that is less than or equal to M_{PSSCH}^{PSFCH}, the UE 115 (e.g., the first UE 115-a and/or the second UE 115-b) allocates the [(i+j·M_{PSSCH}^{PSFCH})·M_{subch, slot}^{PSFCH}, (i+1+j·M_{PSSCH}^{PSFCH})·M_{subch, slot}^{PSFCH}−1] PRBs from the M_{PRB, set}^{PSFCH} PRBs to slot i among the PSSCH slots associated with the PSFCH slot and sub-channel j, where M_{subch, slot}^{PSFCH}=M_{PRB, set}^{PSFCH}/(N_{subch}·M_{PSSCH}^{PSFCH}), 0≤i<M_{PSSCH}^{PSFCH}, 0≤j<N_{subch}, and the allocation may starts in an ascending order of i and continue in an ascending order of j. The UE 115 (e.g., the first UE 115-a and/or the second UE 115-b) may expect that M_{PRB, set}^{PSFCH} is a multiple of N_{subch}·M_{PSSCH}^{PSFCH}.

In the case that the mapping of the reserved resource for a sidelink transmission 215-a to a collision indication 210 is based on the location of the reserved resource, the resource block location for the collision indication 210 may be unclear without prior agreement or standardization between the UEs 115. Accordingly, in some examples, the first UE 115-a and/or the second UE 115-b may calculate the time domain parameter of the PSFCH resource for the collision indication 210 (e.g., the slot for the collision indication 210) based on a time domain resource indexing scheme. In some examples, the time domain resource indexing scheme may begin at a first time domain resource (e.g., i=0) corresponding to the PSFCH resource for the collision indication 210 and increments up to a second time domain resource corresponding to the reserved resource for the sidelink transmission 215-a. In some examples, the time domain resource indexing scheme may begin at a first time domain resource (e.g., i=0) corresponding to the reserved resource for the sidelink transmission 215-a and increments up to a second time domain resource corresponding to the PSFCH resource for the collision indication 210.

Further, without prior agreement, it may be unclear as to whether a collision indication is intended for the second UE 115-b or the third UE 115-c because the resource block location may be mapped from a subchannel index of the reserved resource, and both the second UE 115-b or the third UE 115-c may reserve the same resource. According, in some examples, the first UE 115-a and/or the second UE 115-b may calculate the frequency domain parameter of the PSFCH resource for the collision indication 210 (e.g., the resource block index for the collision indication 210) based on a mapping between the frequency domain resources of the PSFCH resource for the collision indication 210 and the frequency domain resources of the SCI message 205-a. For example, j may be the subchannel index of the resource sending the SCI message 205-a reserving the resources for the sidelink transmission 215-a instead of the subchannel index of the reserved resource for the sidelink transmission 215-a.

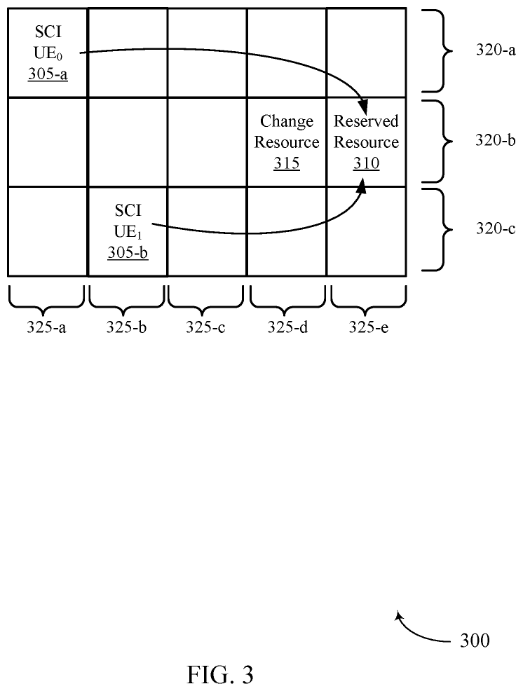

FIG. 3 illustrates an example of a resource diagram 300 that supports techniques for sending a collision indication via a PSFCH in accordance with one or more aspects of the present disclosure. The resource diagram 300 may be implemented by aspects of the wireless communications system 100 and 200. For example, the resource diagram 300 may be implemented by one or more UEs 115 to support sidelink collision indication via a PSFCH.

As described herein, a first UE 115 (e.g., UE₀) may transmit a first SCI message 305-a scheduling a first sidelink transmission on a reserved resource 310. The first SCI message 305-a may be transmitted in a subchannel 320-a and a slot 325-a. A second UE 115 (e.g., UE₁) may transmit a second SCI message 305-b scheduling a second sidelink transmission on the reserved resource 310. The first SCI message 305-a may be transmitted in a subchannel 320-c and a slot 325-b. The reserved resource 310 may be scheduled in subchannel 320-b and slot 325-e. If a collision occurs, the second UE (e.g., UE₁, the UE that transmitted the second SCI message 305-b reserving the reserved resource 310 later) may change resource for the second sidelink transmission to a change resource 315. The change resource may be scheduled in a subchannel 320-b and slot 325-d. The UEs 115 (e.g., UE₀ and UE₁) may expect to receive a collision indication in a PSFCH scheduled in a slot (e.g., slot 325-c) after the scheduling second SCI message 305-b and prior to the change resource 315 and the reserved resource 310.

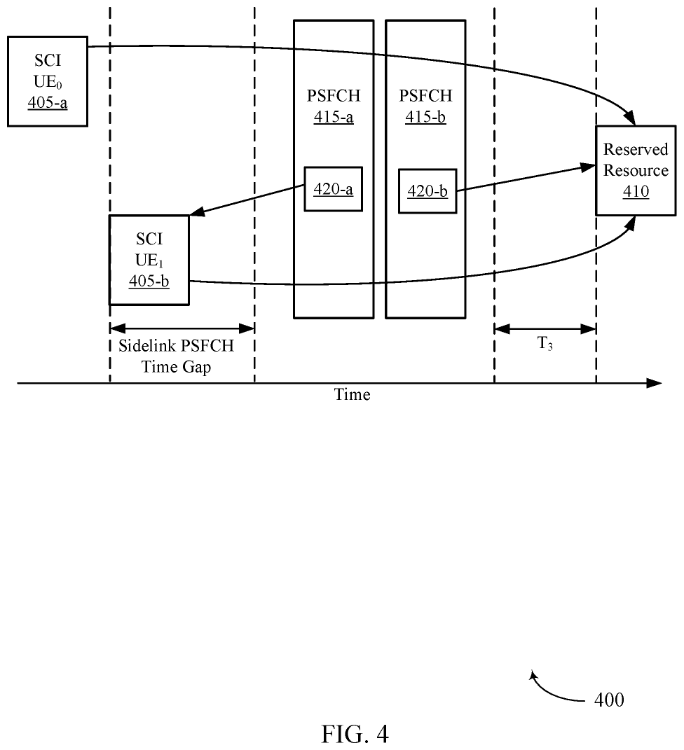

FIG. 4 illustrates an example of a timing diagram 400 that supports techniques for sending a collision indication via a PSFCH in accordance with one or more aspects of the present disclosure. The timing diagram 400 may be implemented by aspects of the wireless communications system 100 and 200. For example, the timing diagram 400 may be implemented by one or more UEs 115 to support sidelink collision indication via a PSFCH.

As described herein, a first UE 115 (e.g., UE₀) may transmit a first SCI message 405-a scheduling a first sidelink transmission on a reserved resource 410. A second UE 115 (e.g., UE₁) may transmit a second SCI message 405-b scheduling a second sidelink transmission on the reserved resource 410. The second UE 115 (e.g., UE₁) may monitor for a collision indication 420 in a PSFCH 415 (e.g., in a PSFCH 415-a or a PSFCH 415-b).

As described herein, in some cases, the mapping of the reserved resource 410 to a collision indication 420-a within a PSFCH 415-a may be based on the location of the second SCI message 405-b reserving the reserved resource 410. A parameter sl-MinTimeGapPSFCH may indicate a minimum time (e.g., number of slots or symbols) between the scheduling second SCI message 405-b and the PSFCH 415-a including the collision indication 420-a.

As described herein, in some cases, the mapping of the reserved resource 410 to a collision indication 420-b within a PSFCH 415-b may be based on the location of the reserved resource 410. A parameter T3 may indicate a minimum time (e.g., number of slots or symbols) between the reserved resource 410 and the PSFCH 415-b including the collision indication 420-b.

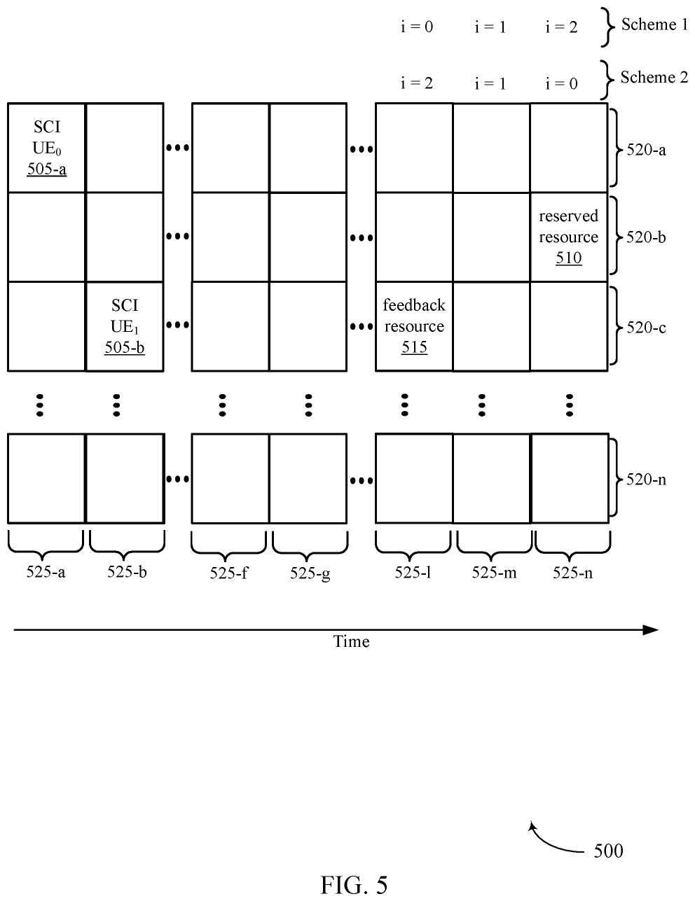

FIG. 5 illustrates an example of a resource diagram 500 that supports techniques for sending a collision indication via a PSFCH in accordance with one or more aspects of the present disclosure. The resource diagram 500 may be implemented by aspects of the wireless communications system 100 and 200. For example, the resource diagram 500 may be implemented by one or more UEs 115 to support sidelink collision indication via a PSFCH.

As described herein, a first UE 115 (e.g., UE₀) may transmit a first SCI message 505-a scheduling a first sidelink transmission on a reserved resource 510. The first SCI message 505-a may be transmitted in a subchannel 520-a and a slot 525-a. A second UE 115 (e.g., UE₁) may transmit a second SCI message 505-b scheduling a second sidelink transmission on the reserved resource 510. The first SCI message 505-a may be transmitted in a subchannel 520-c and a slot 525-b. The reserved resource 310 may be scheduled in subchannel 520-b and slot 525-n.

The second UE 115 (e.g., UE₁) may calculate a sidelink feedback channel resource 515 to monitor for a collision indication for the reserved resource 510. In some cases, the location of the sidelink feedback channel resource 515 may be based on a time domain parameter of a resource mapping between time domain resources of the sidelink feedback channel resource 515 (e.g., slot 525-1) and time domain resources of the reserved resource 510 (e.g., slot 525-n). In some cases, calculating the sidelink feedback channel resource 515 includes calculating the sidelink feedback channel resource 515 based on a time domain resource indexing scheme of the resource mapping, where the time domain resource indexing scheme begins at a first time domain resource (e.g., slot 525-1) corresponding to the sidelink feedback channel resource 515 and increments up (e.g., forward in time) to a second time domain resource (e.g., slot 525-n) corresponding to the reserved resource 510. For example, i=0 at slot 525-1 corresponding to the to the sidelink feedback channel resource 515 and increments up to the slot 525-n corresponding to the reserved resource 510. In some cases, calculating the sidelink feedback channel resource 515 includes calculating the sidelink feedback channel resource 515 based on a time domain resource indexing scheme of the resource mapping, where the time domain resource indexing scheme begins at a first time domain resource (e.g., slot 525-n) corresponding to the reserved resource 510 and increments up to a second time domain resource (e.g., slot 525-1) corresponding to the sidelink feedback channel resource 515. For example, i=0 at slot 525-n corresponding to the reserved resource 510 and increments up (e.g., backward in time) to the slot 525-1 corresponding to the sidelink feedback channel resource 515.

In some cases, calculating the sidelink feedback channel resource 515 includes calculating the sidelink feedback channel resource 515 based on a frequency domain parameter of a resource mapping between frequency domain resources (e.g., the resource block index) of the sidelink feedback channel resource 515 and frequency domain resources (e.g., the subchannel index) of the second SCI message 505-b. For example, the resource block index for the sidelink feedback channel resource 515 may be the same as the resource block index for the second SCI message 505-b.

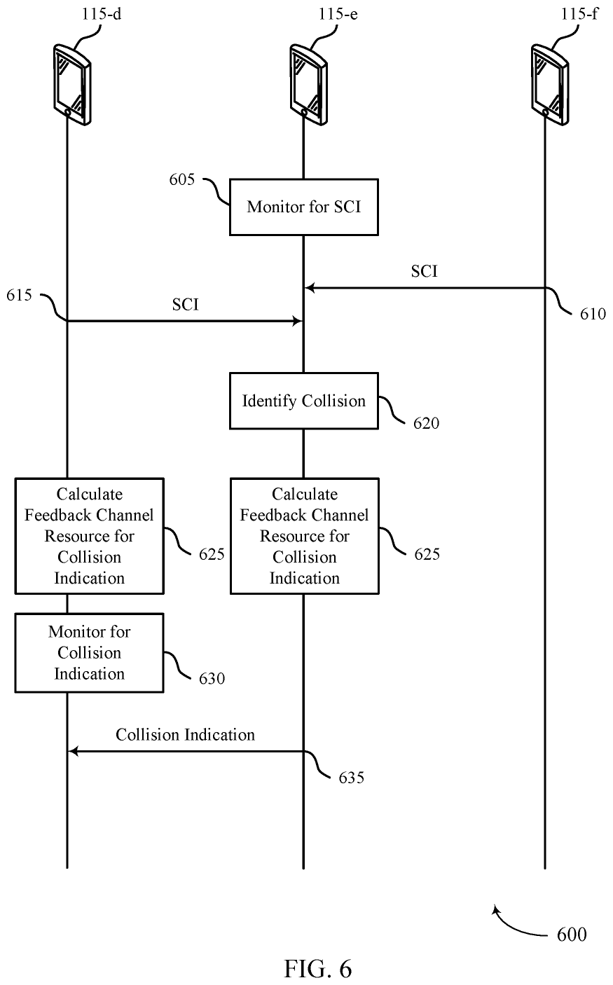

FIG. 6 illustrates an example of a process flow 600 that supports techniques for sending a collision indication via a PSFCH in accordance with one or more aspects of the present disclosure. The process flow 600 may include a UE 115-d, a UE 115-e, and a UE 115-f, which may be examples of a UE 115 as described herein. In the following description of the process flow 600, the operations between the UE 115-d, the UE 115-e, and the UE 115-f may be transmitted in a different order than the example order shown, or the operations performed by the UE 115-d, the UE 115-e, and the UE 115-f may be performed in different orders or at different times. Some operations may also be omitted from the process flow 600, and other operations may be added to the process flow 600.

At 605, the UE 115-e may monitor for sidelink control information.

At 610, the UE 115-f may transmit, and the UE 115-e may receive, sidelink control information indicating a first reserved resource for an upcoming sidelink transmission by the UE 115-f.

At 615, the UE 115-d may transmit, and the UE 115-e may receive, sidelink control information indicating a second reserved resource for an upcoming sidelink transmission by the UE 115-d.

At 620, the UE 115-e may identify whether a collision occurs between the first reserved resource and the second reserved resource. For example, a collision may occur if the first reserved resource and the second reserved resource wholly or partially overlap in time and frequency.

At 625, the UE 115-e and the UE 115-d may calculate a sidelink feedback channel resource of a sidelink feedback channel for a collision indication for the second reserved resource. In some cases, the feedback channel resource of the sidelink feedback channel may be based on a time domain parameter of a resource mapping between time domain resources of the sidelink feedback channel and time domain resources of the reserved resource. In some cases, calculating the sidelink feedback channel resource includes calculating the sidelink feedback channel resource based on a time domain resource indexing scheme of the resource mapping, where the time domain resource indexing scheme begins at a first time domain resource corresponding to the sidelink feedback channel resource and increments up to a second time domain resource corresponding to the reserved resource. In some cases, calculating the sidelink feedback channel resource includes calculating the sidelink feedback channel resource based on a time domain resource indexing scheme of the resource mapping, where the time domain resource indexing scheme begins at a first time domain resource corresponding to the reserved resource and increments up to a second time domain resource corresponding to the sidelink feedback channel resource. In some cases, calculating the sidelink feedback channel resource includes calculating a first slot, where the sidelink feedback channel resource corresponds to the first slot and the reserved resource corresponds to a second slot. The first slot may precede the second slot. In some cases, the sidelink feedback channel resource is a PSFCH.

In some cases, the feedback channel resource of the sidelink feedback channel may be based on a frequency domain parameter of a resource mapping between frequency domain resources of the sidelink feedback channel and frequency domain resources of the sidelink control information message. In some cases, calculating the sidelink feedback channel resource includes calculating a resource block index, where the sidelink feedback channel resource may be a resource block associated with the resource block index. In some cases, the resource block is the same resource block used to transmit the SCI at 615.

At 630, the UE 115-d may monitor for a collision indication for the second reserved resource in the calculated sidelink feedback channel resource.

At 635, if the UE 115-e identified a collision at 620, the UE 115-e may transmit the collision indication in the calculated sidelink feedback channel resource.

If the UE 115-d receives a collision indication based on the monitoring at 630 (e.g., if the UE 115-e transmits the collision indication at 635), the UE 115-d may transmit the upcoming sidelink transmission using a communications resource different from the second reserved resource. If the UE 115-d does not receive a collision indication based on the monitoring at 630 (e.g., if the UE 115-e does not transmit the collision indication at 635), the UE 115-d may transmit the upcoming sidelink transmission using the second reserved resource.

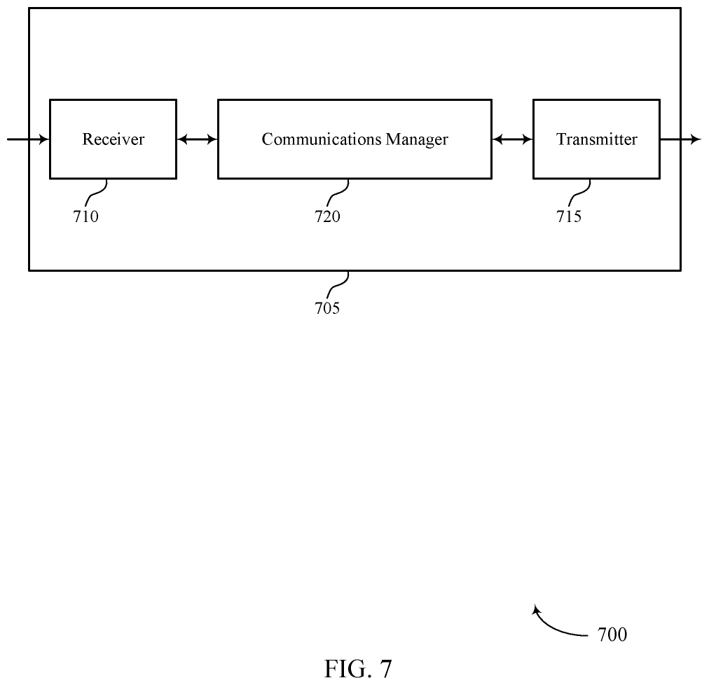

FIG. 7 shows a block diagram 700 of a device 705 that supports techniques for sending a collision indication via a PSFCH in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for sending a collision indication via a PSFCH). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for sending a collision indication via a PSFCH). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of techniques for sending a collision indication via a PSFCH as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. For example, the communications manager 720 may be configured as or otherwise support a means for transmitting a sidelink control information message indicating a reserved resource for an upcoming sidelink transmission. The communications manager 720 may be configured as or otherwise support a means for calculating a sidelink feedback channel resource of a sidelink feedback channel for a collision indication for the reserved resource based on a time domain parameter of a resource mapping between time domain resources of the sidelink feedback channel and time domain resources of the reserved resource. The communications manager 720 may be configured as or otherwise support a means for monitoring the sidelink feedback channel resource for the collision indication.

Additionally, or alternatively, the communications manager 720 may support wireless communications at a first UE in accordance with examples as disclosed herein. For example, the communications manager 720 may be configured as or otherwise support a means for receiving, from a second UE, a sidelink control information message indicating a reserved resource for a first upcoming sidelink transmission. The communications manager 720 may be configured as or otherwise support a means for identifying a collision in the reserved resource. The communications manager 720 may be configured as or otherwise support a means for calculating a sidelink feedback channel resource of a sidelink feedback channel for a collision indication for the reserved resource based on a time domain parameter of a resource mapping between time domain resources of the sidelink feedback channel and time domain resources of the reserved resource. The communications manager 720 may be configured as or otherwise support a means for transmitting the collision indication in the sidelink feedback channel resource.

Additionally, or alternatively, the communications manager 720 may support wireless communications at a UE in accordance with examples as disclosed herein. For example, the communications manager 720 may be configured as or otherwise support a means for transmitting a sidelink control information message indicating a reserved resource for an upcoming sidelink transmission. The communications manager 720 may be configured as or otherwise support a means for calculating a sidelink feedback channel resource of a sidelink feedback channel for a collision indication for the reserved resource based on a frequency domain parameter of a resource mapping between frequency domain resources of the sidelink feedback channel and frequency domain resources of the sidelink control information message. The communications manager 720 may be configured as or otherwise support a means for monitoring the sidelink feedback channel resource for the collision indication.

Additionally, or alternatively, the communications manager 720 may support wireless communications at a first UE in accordance with examples as disclosed herein. For example, the communications manager 720 may be configured as or otherwise support a means for receiving, from a second UE, a sidelink control information message indicating a reserved resource for a first upcoming sidelink transmission. The communications manager 720 may be configured as or otherwise support a means for identifying a collision in the reserved resource. The communications manager 720 may be configured as or otherwise support a means for calculating a sidelink feedback channel resource of a sidelink feedback channel for a collision indication for the reserved resource based on a frequency domain parameter of a resource mapping between frequency domain resources of the sidelink feedback channel and frequency domain resources of the sidelink control information message. The communications manager 720 may be configured as or otherwise support a means for transmitting the collision indication in the sidelink feedback channel resource.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing, and more efficient utilization of communication resources by configuring resources for indicating collisions in reserved resources.

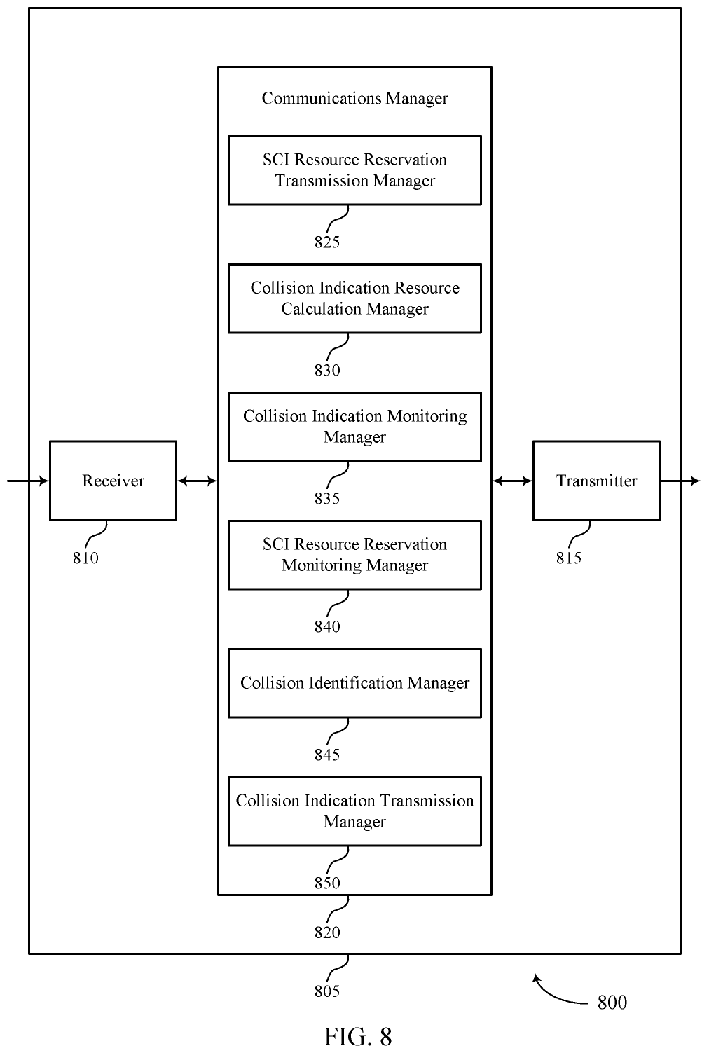

FIG. 8 shows a block diagram 800 of a device 805 that supports techniques for sending a collision indication via a PSFCH in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to techniques for sending a collision indication via a PSFCH). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to techniques for sending a collision indication via a PSFCH). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of techniques for sending a collision indication via a PSFCH as described herein. For example, the communications manager 820 may include an SCI resource reservation transmission manager 825, a collision indication resource calculation manager 830, a collision indication monitoring manager 835, an SCI resource reservation monitoring manager 840, a collision identification manager 845, a collision indication transmission manager 850, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. The SCI resource reservation transmission manager 825 may be configured as or otherwise support a means for transmitting a sidelink control information message indicating a reserved resource for an upcoming sidelink transmission. The collision indication resource calculation manager 830 may be configured as or otherwise support a means for calculating a sidelink feedback channel resource of a sidelink feedback channel for a collision indication for the reserved resource based on a time domain parameter of a resource mapping between time domain resources of the sidelink feedback channel and time domain resources of the reserved resource. The collision indication monitoring manager 835 may be configured as or otherwise support a means for monitoring the sidelink feedback channel resource for the collision indication.

Additionally, or alternatively, the communications manager 820 may support wireless communications at a first UE in accordance with examples as disclosed herein. The SCI resource reservation monitoring manager 840 may be configured as or otherwise support a means for receiving, from a second UE, a sidelink control information message indicating a reserved resource for a first upcoming sidelink transmission. The collision identification manager 845 may be configured as or otherwise support a means for identifying a collision in the reserved resource. The collision indication resource calculation manager 830 may be configured as or otherwise support a means for calculating a sidelink feedback channel resource of a sidelink feedback channel for a collision indication for the reserved resource based on a time domain parameter of a resource mapping between time domain resources of the sidelink feedback channel and time domain resources of the reserved resource. The collision indication transmission manager 850 may be configured as or otherwise support a means for transmitting the collision indication in the sidelink feedback channel resource.

Additionally, or alternatively, the communications manager 820 may support wireless communications at a UE in accordance with examples as disclosed herein. The SCI resource reservation transmission manager 825 may be configured as or otherwise support a means for transmitting a sidelink control information message indicating a reserved resource for an upcoming sidelink transmission. The collision indication resource calculation manager 830 may be configured as or otherwise support a means for calculating a sidelink feedback channel resource of a sidelink feedback channel for a collision indication for the reserved resource based on a frequency domain parameter of a resource mapping between frequency domain resources of the sidelink feedback channel and frequency domain resources of the sidelink control information message. The collision indication monitoring manager 835 may be configured as or otherwise support a means for monitoring the sidelink feedback channel resource for the collision indication.

Additionally, or alternatively, the communications manager 820 may support wireless communications at a first UE in accordance with examples as disclosed herein. The SCI resource reservation monitoring manager 840 may be configured as or otherwise support a means for receiving, from a second UE, a sidelink control information message indicating a reserved resource for a first upcoming sidelink transmission. The collision identification manager 845 may be configured as or otherwise support a means for identifying a collision in the reserved resource. The collision indication resource calculation manager 830 may be configured as or otherwise support a means for calculating a sidelink feedback channel resource of a sidelink feedback channel for a collision indication for the reserved resource based on a frequency domain parameter of a resource mapping between frequency domain resources of the sidelink feedback channel and frequency domain resources of the sidelink control information message. The collision indication transmission manager 850 may be configured as or otherwise support a means for transmitting the collision indication in the sidelink feedback channel resource.

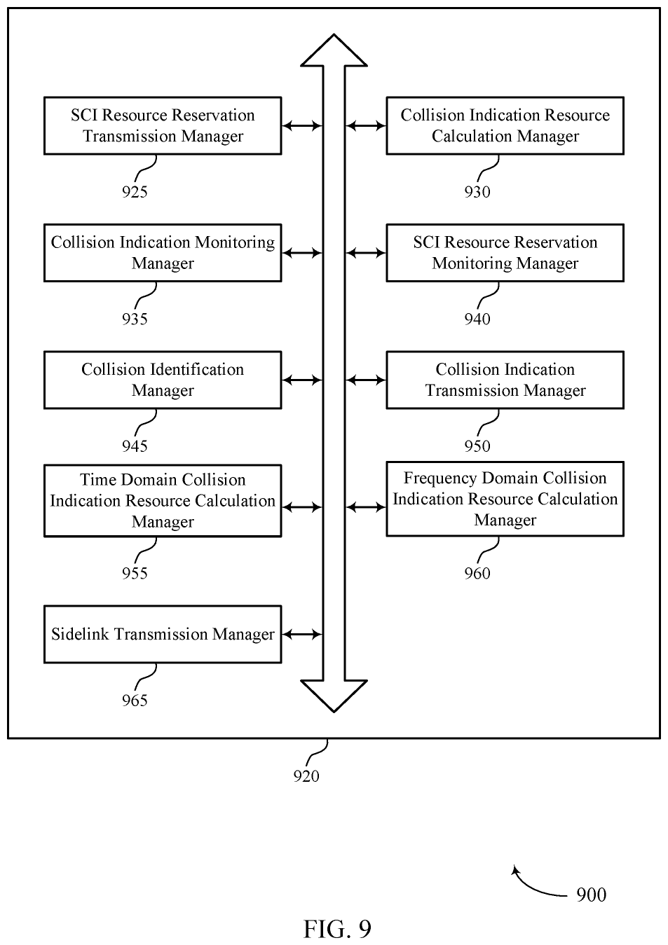

FIG. 9 shows a block diagram 900 of a communications manager 920 that supports techniques for sending a collision indication via a PSFCH in accordance with one or more aspects of the present disclosure. The communications manager 920 may be an example of aspects of a communications manager 720, a communications manager 820, or both, as described herein. The communications manager 920, or various components thereof, may be an example of means for performing various aspects of techniques for sending a collision indication via a PSFCH as described herein. For example, the communications manager 920 may include an SCI resource reservation transmission manager 925, a collision indication resource calculation manager 930, a collision indication monitoring manager 935, an SCI resource reservation monitoring manager 940, a collision identification manager 945, a collision indication transmission manager 950, a time domain collision indication resource calculation manager 955, a frequency domain collision indication resource calculation manager 960, a sidelink transmission manager 965, or any combination thereof. Each of these components may communicate, directly or indirectly, with one another (e.g., via one or more buses).

The communications manager 920 may support wireless communications at a UE in accordance with examples as disclosed herein. The SCI resource reservation transmission manager 925 may be configured as or otherwise support a means for transmitting a sidelink control information message indicating a reserved resource for an upcoming sidelink transmission. The collision indication resource calculation manager 930 may be configured as or otherwise support a means for calculating a sidelink feedback channel resource of a sidelink feedback channel for a collision indication for the reserved resource based on a time domain parameter of a resource mapping between time domain resources of the sidelink feedback channel and time domain resources of the reserved resource. The collision indication monitoring manager 935 may be configured as or otherwise support a means for monitoring the sidelink feedback channel resource for the collision indication.

In some examples, to support calculating the sidelink feedback channel resource, the time domain collision indication resource calculation manager 955 may be configured as or otherwise support a means for calculating the sidelink feedback channel resource based on a time domain resource indexing scheme of the resource mapping, where the time domain resource indexing scheme begins at a first time domain resource corresponding to the sidelink feedback channel resource and increments up to a second time domain resource corresponding to the reserved resource.

In some examples, to support calculating the sidelink feedback channel resource, the time domain collision indication resource calculation manager 955 may be configured as or otherwise support a means for calculating the sidelink feedback channel resource based on a time domain resource indexing scheme of the resource mapping, where the time domain resource indexing scheme begins at a first time domain resource corresponding to the reserved resource and increments up to a second time domain resource corresponding to the sidelink feedback channel resource.

In some examples, to support calculating the sidelink feedback channel resource, the frequency domain collision indication resource calculation manager 960 may be configured as or otherwise support a means for calculating the sidelink feedback channel resource based on a frequency domain parameter of a second resource mapping between frequency domain resources of the sidelink feedback channel and frequency domain resources of the sidelink control information message.

In some examples, to support calculating the sidelink feedback channel resource, the frequency domain collision indication resource calculation manager 960 may be configured as or otherwise support a means for calculating a resource block index, where the sidelink feedback channel resource includes a resource block associated with the resource block index.

In some examples, the collision indication monitoring manager 935 may be configured as or otherwise support a means for receiving an indication of the collision indication in the sidelink feedback channel resource. In some examples, the sidelink transmission manager 965 may be configured as or otherwise support a means for transmitting the upcoming sidelink transmission using a communications resource different from the reserved resource based on the collision indication.

In some examples, the sidelink transmission manager 965 may be configured as or otherwise support a means for transmitting the upcoming sidelink transmission using the reserved resource based on the monitoring the sidelink feedback channel resource.

In some examples, to support calculating the sidelink feedback channel resource, the time domain collision indication resource calculation manager 955 may be configured as or otherwise support a means for calculating a first slot, where the sidelink feedback channel resource includes the first slot and the reserved resource includes a second slot.

In some examples, the first slot precedes the second slot.

In some examples, the sidelink feedback channel resource includes a PSFCH.

Additionally, or alternatively, the communications manager 920 may support wireless communications at a first UE in accordance with examples as disclosed herein. The SCI resource reservation monitoring manager 940 may be configured as or otherwise support a means for receiving, from a second UE, a sidelink control information message indicating a reserved resource for a first upcoming sidelink transmission. The collision identification manager 945 may be configured as or otherwise support a means for identifying a collision in the reserved resource. In some examples, the collision indication resource calculation manager 930 may be configured as or otherwise support a means for calculating a sidelink feedback channel resource of a sidelink feedback channel for a collision indication for the reserved resource based on a time domain parameter of a resource mapping between time domain resources of the sidelink feedback channel and time domain resources of the reserved resource. The collision indication transmission manager 950 may be configured as or otherwise support a means for transmitting the collision indication in the sidelink feedback channel resource.

In some examples, to support calculating the sidelink feedback channel resource, the time domain collision indication resource calculation manager 955 may be configured as or otherwise support a means for calculating the sidelink feedback channel resource based on a time domain resource indexing scheme of the resource mapping, where the time domain resource indexing scheme begins at a first time domain resource corresponding to the sidelink feedback channel resource and increments up to a second time domain resource corresponding to the reserved resource.

In some examples, to support calculating the sidelink feedback channel resource, the time domain collision indication resource calculation manager 955 may be configured as or otherwise support a means for calculating the sidelink feedback channel resource based on a time domain resource indexing scheme of the resource mapping, where the time domain resource indexing scheme begins at a first time domain resource corresponding to the reserved resource and increments up to a second time domain resource corresponding to the sidelink feedback channel resource.

In some examples, to support calculating the sidelink feedback channel resource, the frequency domain collision indication resource calculation manager 960 may be configured as or otherwise support a means for calculating the sidelink feedback channel resource based on a frequency domain parameter of a second resource mapping between frequency domain resources of the sidelink feedback channel and frequency domain resources of the sidelink control information message.

In some examples, to support calculating the sidelink feedback channel resource, the frequency domain collision indication resource calculation manager 960 may be configured as or otherwise support a means for calculating a resource block index, where the sidelink feedback channel resource includes a resource block associated with the resource block index.

In some examples, to support calculating the sidelink feedback channel resource, the time domain collision indication resource calculation manager 955 may be configured as or otherwise support a means for calculating a first slot, where the sidelink feedback channel resource includes the first slot and the reserved resource includes a second slot.

In some examples, the first slot precedes the second slot.

In some examples, the sidelink feedback channel resource includes a PSFCH.

In some examples, the SCI resource reservation monitoring manager 940 may be configured as or otherwise support a means for receiving, from a third UE, a second sidelink control information message indicating the reserved resource for a second upcoming sidelink transmission, where the identifying the collision in the reserved resource is based on the sidelink control information message and the second sidelink control information message.

Additionally, or alternatively, the communications manager 920 may support wireless communications at a UE in accordance with examples as disclosed herein. In some examples, the SCI resource reservation transmission manager 925 may be configured as or otherwise support a means for transmitting a sidelink control information message indicating a reserved resource for an upcoming sidelink transmission. In some examples, the collision indication resource calculation manager 930 may be configured as or otherwise support a means for calculating a sidelink feedback channel resource of a sidelink feedback channel for a collision indication for the reserved resource based on a frequency domain parameter of a resource mapping between frequency domain resources of the sidelink feedback channel and frequency domain resources of the sidelink control information message. In some examples, the collision indication monitoring manager 935 may be configured as or otherwise support a means for monitoring the sidelink feedback channel resource for the collision indication.

In some examples, to support calculating the sidelink feedback channel resource, the frequency domain collision indication resource calculation manager 960 may be configured as or otherwise support a means for calculating a resource block index, where the sidelink feedback channel resource includes a resource block associated with the resource block index.

In some examples, the sidelink control information message includes the resource block.

In some examples, to support calculating the sidelink feedback channel resource, the time domain collision indication resource calculation manager 955 may be configured as or otherwise support a means for calculating the sidelink feedback channel resource based on a time domain parameter of a second resource mapping between time domain resources of the sidelink feedback channel and time domain resources of the reserved resource.

In some examples, the collision indication monitoring manager 935 may be configured as or otherwise support a means for receiving an indication of the collision indication in the sidelink feedback channel resource. In some examples, the sidelink transmission manager 965 may be configured as or otherwise support a means for transmitting the upcoming sidelink transmission using a communications resource different from the reserved resource based on the collision indication.

In some examples, the sidelink transmission manager 965 may be configured as or otherwise support a means for transmitting the upcoming sidelink transmission using the reserved resource based on the monitoring the sidelink feedback channel resource.

Additionally, or alternatively, the communications manager 920 may support wireless communications at a first UE in accordance with examples as disclosed herein. In some examples, the SCI resource reservation monitoring manager 940 may be configured as or otherwise support a means for receiving, from a second UE, a sidelink control information message indicating a reserved resource for a first upcoming sidelink transmission. In some examples, the collision identification manager 945 may be configured as or otherwise support a means for identifying a collision in the reserved resource. In some examples, the collision indication resource calculation manager 930 may be configured as or otherwise support a means for calculating a sidelink feedback channel resource of a sidelink feedback channel for a collision indication for the reserved resource based on a frequency domain parameter of a resource mapping between frequency domain resources of the sidelink feedback channel and frequency domain resources of the sidelink control information message. In some examples, the collision indication transmission manager 950 may be configured as or otherwise support a means for transmitting the collision indication in the sidelink feedback channel resource.

In some examples, to support calculating the sidelink feedback channel resource, the frequency domain collision indication resource calculation manager 960 may be configured as or otherwise support a means for calculating a resource block index, where the sidelink feedback channel resource includes a resource block associated with the resource block index.

In some examples, the sidelink control information message includes the resource block.

In some examples, to support calculating the sidelink feedback channel resource, the time domain collision indication resource calculation manager 955 may be configured as or otherwise support a means for calculating the sidelink feedback channel resource based on a time domain parameter of a second resource mapping between time domain resources of the sidelink feedback channel and time domain resources of the reserved resource.

In some examples, the SCI resource reservation monitoring manager 940 may be configured as or otherwise support a means for receiving, from a third UE, a second sidelink control information message indicating the reserved resource for a second upcoming sidelink transmission, where the identifying the collision in the reserved resource is based on the sidelink control information message and the second sidelink control information message.

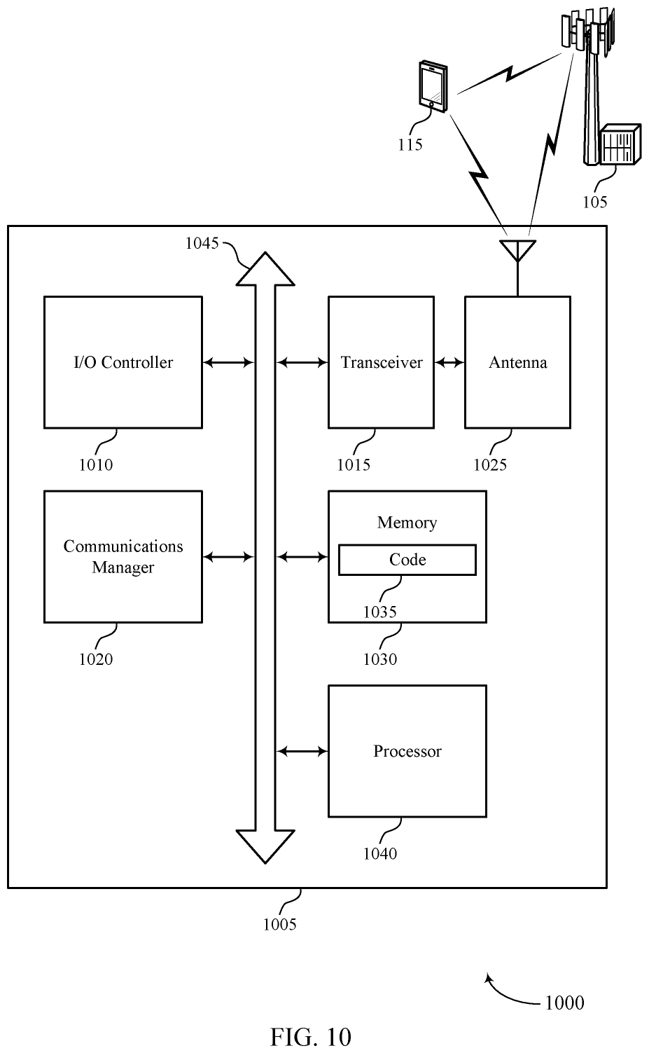

FIG. 10 shows a diagram of a system 1000 including a device 1005 that supports techniques for sending a collision indication via a PSFCH in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting techniques for sending a collision indication via a PSFCH). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a UE in accordance with examples as disclosed herein. For example, the communications manager 1020 may be configured as or otherwise support a means for transmitting a sidelink control information message indicating a reserved resource for an upcoming sidelink transmission. The communications manager 1020 may be configured as or otherwise support a means for calculating a sidelink feedback channel resource of a sidelink feedback channel for a collision indication for the reserved resource based on a time domain parameter of a resource mapping between time domain resources of the sidelink feedback channel and time domain resources of the reserved resource. The communications manager 1020 may be configured as or otherwise support a means for monitoring the sidelink feedback channel resource for the collision indication.

Additionally, or alternatively, the communications manager 1020 may support wireless communications at a first UE in accordance with examples as disclosed herein. For example, the communications manager 1020 may be configured as or otherwise support a means for receiving, from a second UE, a sidelink control information message indicating a reserved resource for a first upcoming sidelink transmission. The communications manager 1020 may be configured as or otherwise support a means for identifying a collision in the reserved resource. The communications manager 1020 may be configured as or otherwise support a means for calculating a sidelink feedback channel resource of a sidelink feedback channel for a collision indication for the reserved resource based on a time domain parameter of a resource mapping between time domain resources of the sidelink feedback channel and time domain resources of the reserved resource. The communications manager 1020 may be configured as or otherwise support a means for transmitting the collision indication in the sidelink feedback channel resource.

Additionally, or alternatively, the communications manager 1020 may support wireless communications at a UE in accordance with examples as disclosed herein. For example, the communications manager 1020 may be configured as or otherwise support a means for transmitting a sidelink control information message indicating a reserved resource for an upcoming sidelink transmission. The communications manager 1020 may be configured as or otherwise support a means for calculating a sidelink feedback channel resource of a sidelink feedback channel for a collision indication for the reserved resource based on a frequency domain parameter of a resource mapping between frequency domain resources of the sidelink feedback channel and frequency domain resources of the sidelink control information message. The communications manager 1020 may be configured as or otherwise support a means for monitoring the sidelink feedback channel resource for the collision indication.

Additionally, or alternatively, the communications manager 1020 may support wireless communications at a first UE in accordance with examples as disclosed herein. For example, the communications manager 1020 may be configured as or otherwise support a means for receiving, from a second UE, a sidelink control information message indicating a reserved resource for a first upcoming sidelink transmission. The communications manager 1020 may be configured as or otherwise support a means for identifying a collision in the reserved resource. The communications manager 1020 may be configured as or otherwise support a means for calculating a sidelink feedback channel resource of a sidelink feedback channel for a collision indication for the reserved resource based on a frequency domain parameter of a resource mapping between frequency domain resources of the sidelink feedback channel and frequency domain resources of the sidelink control information message. The communications manager 1020 may be configured as or otherwise support a means for transmitting the collision indication in the sidelink feedback channel resource.

By including or configuring the communications manager 1020 in accordance with examples as described herein, the device 1005 may support techniques for improved communication reliability, more efficient utilization of communication resources, and improved coordination between devices by configuring resources for indicating collisions in reserved resources.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of techniques for sending a collision indication via a PSFCH as described herein, or the processor 1040 and the memory 1030 may be otherwise configured to perform or support such operations.

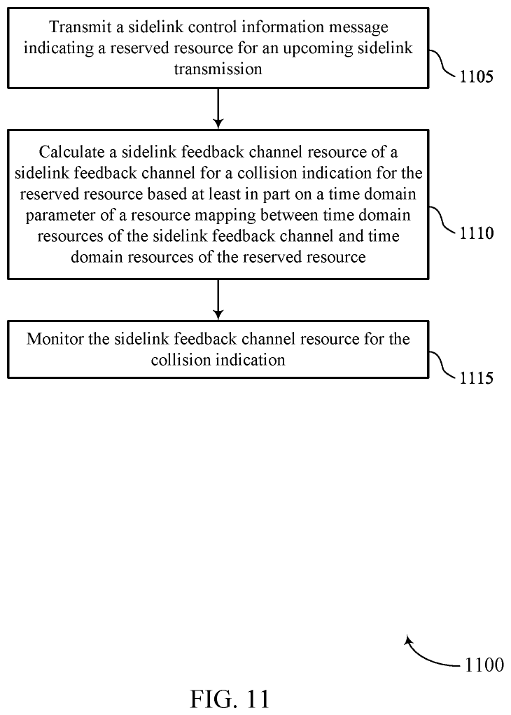

FIG. 11 shows a flowchart illustrating a method 1100 that supports techniques for sending a collision indication via a PSFCH in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include transmitting a sidelink control information message indicating a reserved resource for an upcoming sidelink transmission. The operations of 1105 may be performed in accordance with examples as disclosed herein. In some examples, aspects of the operations of 1105 may be performed by an SCI resource reservation transmission manager 925 as described with reference to FIG. 9.

At 1110, the method may include calculating a sidelink feedback channel resource of a sidelink feedback channel for a collision indication for the reserved resource based on a time domain parameter of a resource mapping between time domain resources of the sidelink feedback channel and time domain resources of the reserved resource. The operations of 1110 may be performed in accordance with examples as disclosed herein. In some examples, aspects of the operations of 1110 may be performed by a collision indication resource calculation manager 930 as described with reference to FIG. 9.

At 1115, the method may include monitoring the sidelink feedback channel resource for the collision indication. The operations of 1115 may be performed in accordance with examples as disclosed herein. In some examples, aspects of the operations of 1115 may be performed by a collision indication monitoring manager 935 as described with reference to FIG. 9.

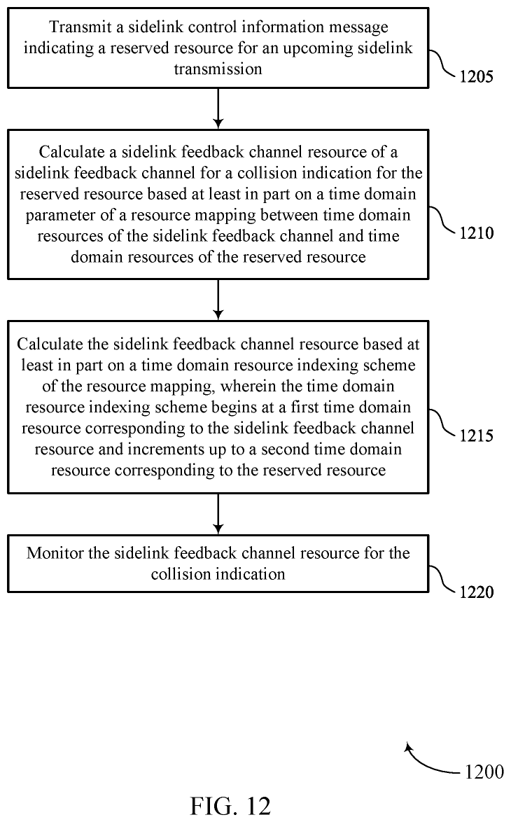

FIG. 12 shows a flowchart illustrating a method 1200 that supports techniques for sending a collision indication via a PSFCH in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include transmitting a sidelink control information message indicating a reserved resource for an upcoming sidelink transmission. The operations of 1205 may be performed in accordance with examples as disclosed herein. In some examples, aspects of the operations of 1205 may be performed by an SCI resource reservation transmission manager 925 as described with reference to FIG. 9.

At 1210, the method may include calculating a sidelink feedback channel resource of a sidelink feedback channel for a collision indication for the reserved resource based on a time domain parameter of a resource mapping between time domain resources of the sidelink feedback channel and time domain resources of the reserved resource. The operations of 1210 may be performed in accordance with examples as disclosed herein. In some examples, aspects of the operations of 1210 may be performed by a collision indication resource calculation manager 930 as described with reference to FIG. 9.

At 1215, the method may include calculating the sidelink feedback channel resource based on a time domain resource indexing scheme of the resource mapping, where the time domain resource indexing scheme begins at a first time domain resource corresponding to the sidelink feedback channel resource and increments up to a second time domain resource corresponding to the reserved resource. The operations of 1215 may be performed in accordance with examples as disclosed herein. In some examples, aspects of the operations of 1215 may be performed by a time domain collision indication resource calculation manager 955 as described with reference to FIG. 9.

At 1220, the method may include monitoring the sidelink feedback channel resource for the collision indication. The operations of 1220 may be performed in accordance with examples as disclosed herein. In some examples, aspects of the operations of 1220 may be performed by a collision indication monitoring manager 935 as described with reference to FIG. 9.

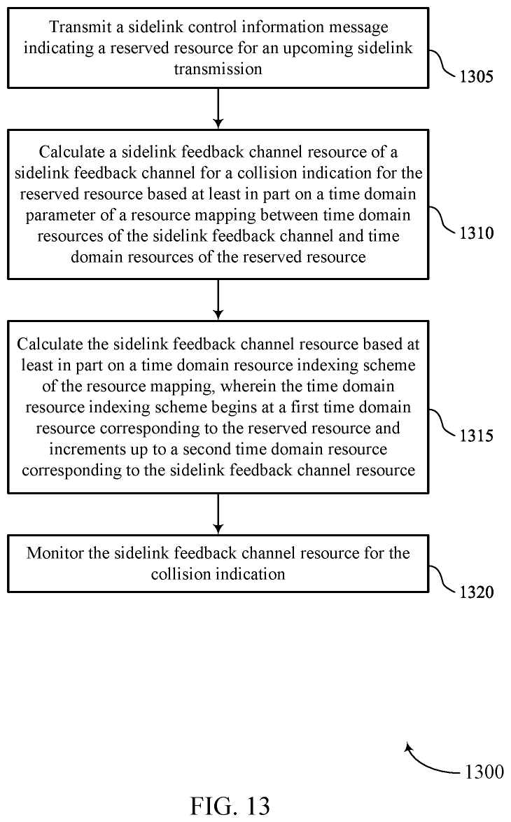

FIG. 13 shows a flowchart illustrating a method 1300 that supports techniques for sending a collision indication via a PSFCH in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include transmitting a sidelink control information message indicating a reserved resource for an upcoming sidelink transmission. The operations of 1305 may be performed in accordance with examples as disclosed herein. In some examples, aspects of the operations of 1305 may be performed by an SCI resource reservation transmission manager 925 as described with reference to FIG. 9.

At 1310, the method may include calculating a sidelink feedback channel resource of a sidelink feedback channel for a collision indication for the reserved resource based on a time domain parameter of a resource mapping between time domain resources of the sidelink feedback channel and time domain resources of the reserved resource. The operations of 1310 may be performed in accordance with examples as disclosed herein. In some examples, aspects of the operations of 1310 may be performed by a collision indication resource calculation manager 930 as described with reference to FIG. 9.

At 1315, the method may include calculating the sidelink feedback channel resource based on a time domain resource indexing scheme of the resource mapping, where the time domain resource indexing scheme begins at a first time domain resource corresponding to the reserved resource and increments up to a second time domain resource corresponding to the sidelink feedback channel resource. The operations of 1315 may be performed in accordance with examples as disclosed herein. In some examples, aspects of the operations of 1315 may be performed by a time domain collision indication resource calculation manager 955 as described with reference to FIG. 9.

At 1320, the method may include monitoring the sidelink feedback channel resource for the collision indication. The operations of 1320 may be performed in accordance with examples as disclosed herein. In some examples, aspects of the operations of 1320 may be performed by a collision indication monitoring manager 935 as described with reference to FIG. 9.

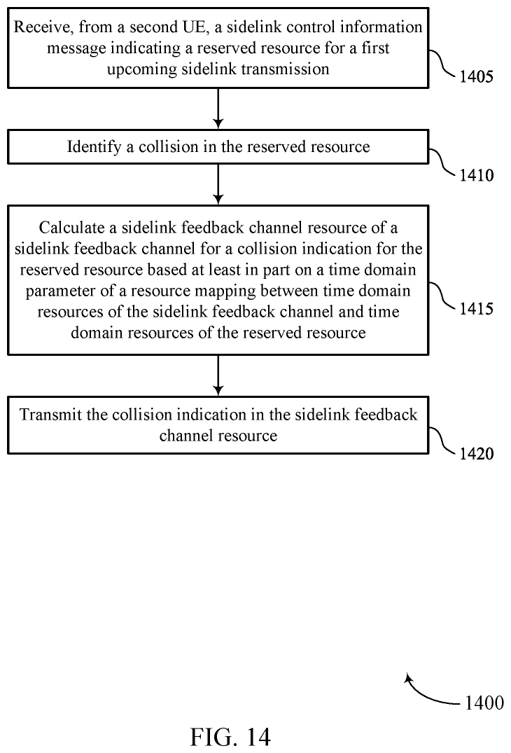

FIG. 14 shows a flowchart illustrating a method 1400 that supports techniques for sending a collision indication via a PSFCH in accordance with one or more aspects of the present disclosure. The operations of the method 1400 may be implemented by a UE or its components as described herein. For example, the operations of the method 1400 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1405, the method may include receiving, from a second UE, a sidelink control information message indicating a reserved resource for a first upcoming sidelink transmission. The operations of 1405 may be performed in accordance with examples as disclosed herein. In some examples, aspects of the operations of 1405 may be performed by an SCI resource reservation monitoring manager 940 as described with reference to FIG. 9.

At 1410, the method may include identifying a collision in the reserved resource. The operations of 1410 may be performed in accordance with examples as disclosed herein. In some examples, aspects of the operations of 1410 may be performed by a collision identification manager 945 as described with reference to FIG. 9.

At 1415, the method may include calculating a sidelink feedback channel resource of a sidelink feedback channel for a collision indication for the reserved resource based on a time domain parameter of a resource mapping between time domain resources of the sidelink feedback channel and time domain resources of the reserved resource. The operations of 1415 may be performed in accordance with examples as disclosed herein. In some examples, aspects of the operations of 1415 may be performed by a collision indication resource calculation manager 930 as described with reference to FIG. 9.

At 1420, the method may include transmitting the collision indication in the sidelink feedback channel resource. The operations of 1420 may be performed in accordance with examples as disclosed herein. In some examples, aspects of the operations of 1420 may be performed by a collision indication transmission manager 950 as described with reference to FIG. 9.

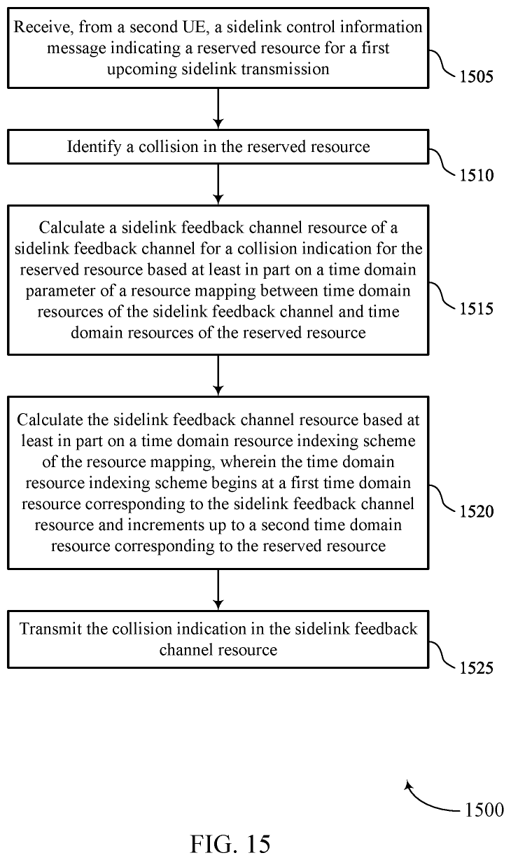

FIG. 15 shows a flowchart illustrating a method 1500 that supports techniques for sending a collision indication via a PSFCH in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a second UE, a sidelink control information message indicating a reserved resource for a first upcoming sidelink transmission. The operations of 1505 may be performed in accordance with examples as disclosed herein. In some examples, aspects of the operations of 1505 may be performed by an SCI resource reservation monitoring manager 940 as described with reference to FIG. 9.

At 1510, the method may include identifying a collision in the reserved resource. The operations of 1510 may be performed in accordance with examples as disclosed herein. In some examples, aspects of the operations of 1510 may be performed by a collision identification manager 945 as described with reference to FIG. 9.

At 1515, the method may include calculating a sidelink feedback channel resource of a sidelink feedback channel for a collision indication for the reserved resource based on a time domain parameter of a resource mapping between time domain resources of the sidelink feedback channel and time domain resources of the reserved resource. The operations of 1515 may be performed in accordance with examples as disclosed herein. In some examples, aspects of the operations of 1515 may be performed by a collision indication resource calculation manager 930 as described with reference to FIG. 9.

At 1520, the method may include calculating the sidelink feedback channel resource based on a time domain resource indexing scheme of the resource mapping, where the time domain resource indexing scheme begins at a first time domain resource corresponding to the sidelink feedback channel resource and increments up to a second time domain resource corresponding to the reserved resource. The operations of 1520 may be performed in accordance with examples as disclosed herein. In some examples, aspects of the operations of 1520 may be performed by a time domain collision indication resource calculation manager 955 as described with reference to FIG. 9.

At 1525, the method may include transmitting the collision indication in the sidelink feedback channel resource. The operations of 1525 may be performed in accordance with examples as disclosed herein. In some examples, aspects of the operations of 1525 may be performed by a collision indication transmission manager 950 as described with reference to FIG. 9.

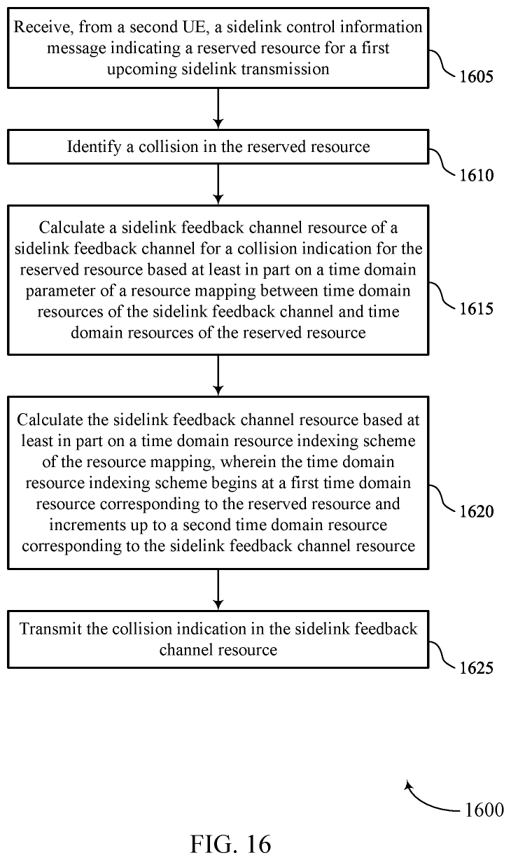

FIG. 16 shows a flowchart illustrating a method 1600 that supports techniques for sending a collision indication via a PSFCH in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a second UE, a sidelink control information message indicating a reserved resource for a first upcoming sidelink transmission. The operations of 1605 may be performed in accordance with examples as disclosed herein. In some examples, aspects of the operations of 1605 may be performed by an SCI resource reservation monitoring manager 940 as described with reference to FIG. 9.

At 1610, the method may include identifying a collision in the reserved resource. The operations of 1610 may be performed in accordance with examples as disclosed herein. In some examples, aspects of the operations of 1610 may be performed by a collision identification manager 945 as described with reference to FIG. 9.

At 1615, the method may include calculating a sidelink feedback channel resource of a sidelink feedback channel for a collision indication for the reserved resource based on a time domain parameter of a resource mapping between time domain resources of the sidelink feedback channel and time domain resources of the reserved resource. The operations of 1615 may be performed in accordance with examples as disclosed herein. In some examples, aspects of the operations of 1615 may be performed by a collision indication resource calculation manager 930 as described with reference to FIG. 9.

At 1620, the method may include calculating the sidelink feedback channel resource based on a time domain resource indexing scheme of the resource mapping, where the time domain resource indexing scheme begins at a first time domain resource corresponding to the reserved resource and increments up to a second time domain resource corresponding to the sidelink feedback channel resource. The operations of 1620 may be performed in accordance with examples as disclosed herein. In some examples, aspects of the operations of 1620 may be performed by a time domain collision indication resource calculation manager 955 as described with reference to FIG. 9.

At 1625, the method may include transmitting the collision indication in the sidelink feedback channel resource. The operations of 1625 may be performed in accordance with examples as disclosed herein. In some examples, aspects of the operations of 1625 may be performed by a collision indication transmission manager 950 as described with reference to FIG. 9.

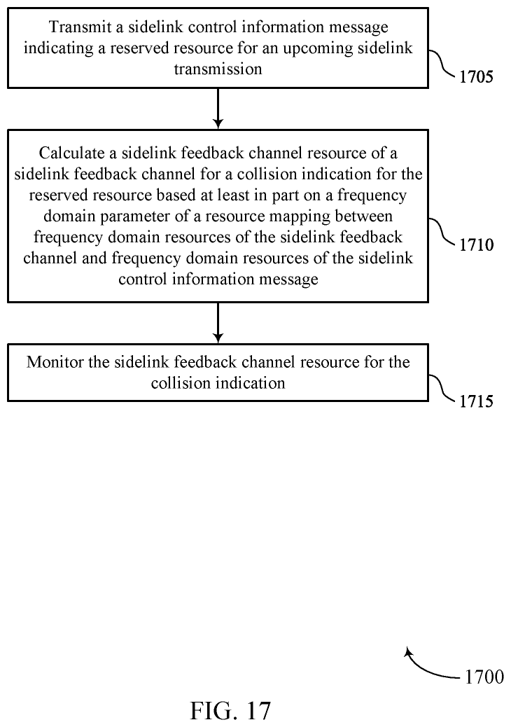

FIG. 17 shows a flowchart illustrating a method 1700 that supports techniques for sending a collision indication via a PSFCH in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting a sidelink control information message indicating a reserved resource for an upcoming sidelink transmission. The operations of 1705 may be performed in accordance with examples as disclosed herein. In some examples, aspects of the operations of 1705 may be performed by an SCI resource reservation transmission manager 925 as described with reference to FIG. 9.

At 1710, the method may include calculating a sidelink feedback channel resource of a sidelink feedback channel for a collision indication for the reserved resource based on a frequency domain parameter of a resource mapping between frequency domain resources of the sidelink feedback channel and frequency domain resources of the sidelink control information message. The operations of 1710 may be performed in accordance with examples as disclosed herein. In some examples, aspects of the operations of 1710 may be performed by a collision indication resource calculation manager 930 as described with reference to FIG. 9.

At 1715, the method may include monitoring the sidelink feedback channel resource for the collision indication. The operations of 1715 may be performed in accordance with examples as disclosed herein. In some examples, aspects of the operations of 1715 may be performed by a collision indication monitoring manager 935 as described with reference to FIG. 9.

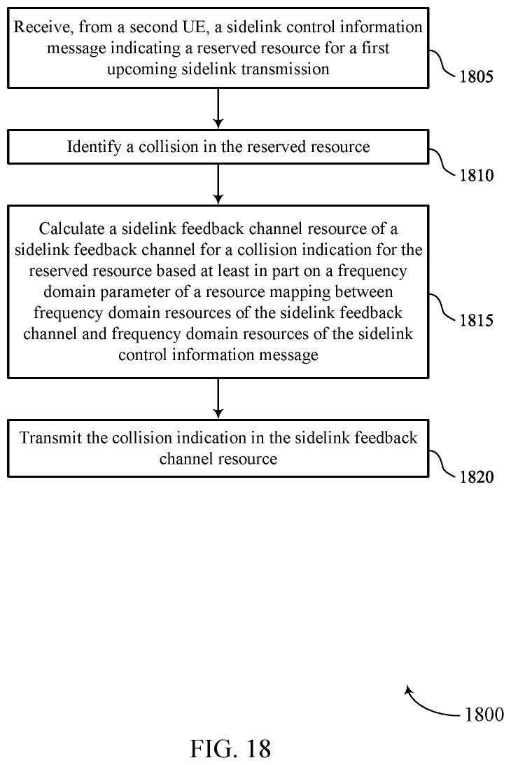

FIG. 18 shows a flowchart illustrating a method 1800 that supports techniques for sending a collision indication via a PSFCH in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include receiving, from a second UE, a sidelink control information message indicating a reserved resource for a first upcoming sidelink transmission. The operations of 1805 may be performed in accordance with examples as disclosed herein. In some examples, aspects of the operations of 1805 may be performed by an SCI resource reservation monitoring manager 940 as described with reference to FIG. 9.

At 1810, the method may include identifying a collision in the reserved resource. The operations of 1810 may be performed in accordance with examples as disclosed herein. In some examples, aspects of the operations of 1810 may be performed by a collision identification manager 945 as described with reference to FIG. 9.

At 1815, the method may include calculating a sidelink feedback channel resource of a sidelink feedback channel for a collision indication for the reserved resource based on a frequency domain parameter of a resource mapping between frequency domain resources of the sidelink feedback channel and frequency domain resources of the sidelink control information message. The operations of 1815 may be performed in accordance with examples as disclosed herein. In some examples, aspects of the operations of 1815 may be performed by a collision indication resource calculation manager 930 as described with reference to FIG. 9.

At 1820, the method may include transmitting the collision indication in the sidelink feedback channel resource. The operations of 1820 may be performed in accordance with examples as disclosed herein. In some examples, aspects of the operations of 1820 may be performed by a collision indication transmission manager 950 as described with reference to FIG. 9.

The following provides an overview of aspects of the present disclosure:

Aspect 1: A method for wireless communications at a UE, comprising: transmitting a SCI message indicating a reserved resource for an upcoming sidelink transmission; calculating a sidelink feedback channel resource of a sidelink feedback channel for a collision indication for the reserved resource based at least in part on a time domain parameter of a resource mapping between time domain resources of the sidelink feedback channel and time domain resources of the reserved resource; and monitoring the sidelink feedback channel resource for the collision indication.

Aspect 2: The method of aspect 1, wherein calculating the sidelink feedback channel resource comprises: calculating the sidelink feedback channel resource based at least in part on a time domain resource indexing scheme of the resource mapping, wherein the time domain resource indexing scheme begins at a first time domain resource corresponding to the sidelink feedback channel resource and increments up to a second time domain resource corresponding to the reserved resource.

Aspect 3: The method of any of aspects 1 through 2, wherein calculating the sidelink feedback channel resource comprises: calculating the sidelink feedback channel resource based at least in part on a time domain resource indexing scheme of the resource mapping, wherein the time domain resource indexing scheme begins at a first time domain resource corresponding to the reserved resource and increments up to a second time domain resource corresponding to the sidelink feedback channel resource.

Aspect 4: The method of any of aspects 1 through 3, wherein calculating the sidelink feedback channel resource comprises: calculating the sidelink feedback channel resource based at least in part on a frequency domain parameter of a second resource mapping between frequency domain resources of the sidelink feedback channel and frequency domain resources of the SCI message.

Aspect 5: The method of aspect 4, wherein calculating the sidelink feedback channel resource comprises: calculating a resource block index, wherein the sidelink feedback channel resource comprises a resource block associated with the resource block index.

Aspect 6: The method of any of aspects 1 through 5, further comprising: receiving an indication of the collision indication in the sidelink feedback channel resource; and transmitting the upcoming sidelink transmission using a communications resource different from the reserved resource based at least in part on the collision indication.

Aspect 7: The method of any of aspects 1 through 6, further comprising: transmitting the upcoming sidelink transmission using the reserved resource based at least in part on the monitoring the sidelink feedback channel resource.

Aspect 8: The method of any of aspects 1 through 7, wherein calculating the sidelink feedback channel resource comprises: calculating a first slot, wherein the sidelink feedback channel resource comprises the first slot and the reserved resource comprises a second slot.

Aspect 9: The method of aspect 8, wherein the first slot precedes the second slot.

Aspect 10: The method of any of aspects 1 through 9, wherein the sidelink feedback channel resource comprises a PSFCH.

Aspect 11: A method for wireless communications at a first UE, comprising: receiving, from a second UE, a SCI message indicating a reserved resource for a first upcoming sidelink transmission; identifying a collision in the reserved resource; calculating a sidelink feedback channel resource of a sidelink feedback channel for a collision indication for the reserved resource based at least in part on a time domain parameter of a resource mapping between time domain resources of the sidelink feedback channel and time domain resources of the reserved resource; and transmitting the collision indication in the sidelink feedback channel resource.

Aspect 12: The method of aspect 11, wherein calculating the sidelink feedback channel resource comprises: calculating the sidelink feedback channel resource based at least in part on a time domain resource indexing scheme of the resource mapping, wherein the time domain resource indexing scheme begins at a first time domain resource corresponding to the sidelink feedback channel resource and increments up to a second time domain resource corresponding to the reserved resource.

Aspect 13: The method of any of aspects 11 through 12, wherein calculating the sidelink feedback channel resource comprises: calculating the sidelink feedback channel resource based at least in part on a time domain resource indexing scheme of the resource mapping, wherein the time domain resource indexing scheme begins at a first time domain resource corresponding to the reserved resource and increments up to a second time domain resource corresponding to the sidelink feedback channel resource.

Aspect 14: The method of any of aspects 11 through 13, wherein calculating the sidelink feedback channel resource comprises: calculating the sidelink feedback channel resource based at least in part on a frequency domain parameter of a second resource mapping between frequency domain resources of the sidelink feedback channel and frequency domain resources of the SCI message.

Aspect 15: The method of aspect 14, wherein calculating the sidelink feedback channel resource comprises: calculating a resource block index, wherein the sidelink feedback channel resource comprises a resource block associated with the resource block index.

Aspect 16: The method of any of aspects 11 through 15, wherein calculating the sidelink feedback channel resource comprises: calculating a first slot, wherein the sidelink feedback channel resource comprises the first slot and the reserved resource comprises a second slot.

Aspect 17: The method of aspect 16, wherein the first slot precedes the second slot.

Aspect 18: The method of any of aspects 11 through 17, wherein the sidelink feedback channel resource comprises a PSFCH.

Aspect 19: The method of any of aspects 11 through 18, further comprising: receiving, from a third UE, a second SCI message indicating the reserved resource for a second upcoming sidelink transmission, wherein the identifying the collision in the reserved resource is based at least in part on the SCI message and the second SCI message.

Aspect 20: A method for wireless communications at a UE, comprising: transmitting a SCI message indicating a reserved resource for an upcoming sidelink transmission; calculating a sidelink feedback channel resource of a sidelink feedback channel for a collision indication for the reserved resource based at least in part on a frequency domain parameter of a resource mapping between frequency domain resources of the sidelink feedback channel and frequency domain resources of the SCI message; and monitoring the sidelink feedback channel resource for the collision indication.

Aspect 21: The method of aspect 20, wherein calculating the sidelink feedback channel resource comprises: calculating a resource block index, wherein the sidelink feedback channel resource comprises a resource block associated with the resource block index.

Aspect 22: The method of aspect 21, wherein the SCI message comprises the resource block.

Aspect 23: The method of any of aspects 20 through 22, wherein calculating the sidelink feedback channel resource comprises: calculating the sidelink feedback channel resource based at least in part on a time domain parameter of a second resource mapping between time domain resources of the sidelink feedback channel and time domain resources of the reserved resource.

Aspect 24: The method of any of aspects 20 through 23, further comprising: receiving an indication of the collision indication in the sidelink feedback channel resource; and transmitting the upcoming sidelink transmission using a communications resource different from the reserved resource based at least in part on the collision indication.

Aspect 25: The method of any of aspects 20 through 24, further comprising: transmitting the upcoming sidelink transmission using the reserved resource based at least in part on the monitoring the sidelink feedback channel resource.

Aspect 26: A method for wireless communications at a first UE, comprising: receiving, from a second UE, a SCI message indicating a reserved resource for a first upcoming sidelink transmission; identifying a collision in the reserved resource; calculating a sidelink feedback channel resource of a sidelink feedback channel for a collision indication for the reserved resource based at least in part on a frequency domain parameter of a resource mapping between frequency domain resources of the sidelink feedback channel and frequency domain resources of the SCI message; and transmitting the collision indication in the sidelink feedback channel resource.

Aspect 27: The method of aspect 26, wherein calculating the sidelink feedback channel resource comprises: calculating a resource block index, wherein the sidelink feedback channel resource comprises a resource block associated with the resource block index.

Aspect 28: The method of aspect 27, wherein the SCI message comprises the resource block.

Aspect 29: The method of any of aspects 26 through 28, wherein calculating the sidelink feedback channel resource comprises: calculating the sidelink feedback channel resource based at least in part on a time domain parameter of a second resource mapping between time domain resources of the sidelink feedback channel and time domain resources of the reserved resource.

Aspect 30: The method of any of aspects 26 through 29, further comprising: receiving, from a third UE, a second SCI message indicating the reserved resource for a second upcoming sidelink transmission, wherein the identifying the collision in the reserved resource is based at least in part on the SCI message and the second SCI message.

Aspect 31: An apparatus for wireless communications at a UE, comprising a processor; memory coupled with the processor; and instructions stored in the memory and executable by the processor to cause the apparatus to perform a method of any of aspects 1 through 10.

Aspect 32: An apparatus for wireless communications at a UE, comprising at least one means for performing a method of any of aspects 1 through 10.

Aspect 33: A non-transitory computer-readable medium storing code for wireless communications at a UE, the code comprising instructions executable by a processor to perform a method of any of aspects 1 through 10.

Aspect 34: An apparatus for wireless communications at a first UE, comprising a processor; memory coupled with the processor; and instructions stored in the memory and executable by the processor to cause the apparatus to perform a method of any of aspects 11 through 19.

Aspect 35: An apparatus for wireless communications at a first UE, comprising at least one means for performing a method of any of aspects 11 through 19.

Aspect 36: A non-transitory computer-readable medium storing code for wireless communications at a first UE, the code comprising instructions executable by a processor to perform a method of any of aspects 11 through 19.

Aspect 37: An apparatus for wireless communications at a UE, comprising a processor; memory coupled with the processor; and instructions stored in the memory and executable by the processor to cause the apparatus to perform a method of any of aspects 20 through 25.

Aspect 38: An apparatus for wireless communications at a UE, comprising at least one means for performing a method of any of aspects 20 through 25.

Aspect 39: A non-transitory computer-readable medium storing code for wireless communications at a UE, the code comprising instructions executable by a processor to perform a method of any of aspects 20 through 25.

Aspect 40: An apparatus for wireless communications at a first UE, comprising a processor; memory coupled with the processor; and instructions stored in the memory and executable by the processor to cause the apparatus to perform a method of any of aspects 26 through 30.

Aspect 41: An apparatus for wireless communications at a first UE, comprising at least one means for performing a method of any of aspects 26 through 30.

Aspect 42: A non-transitory computer-readable medium storing code for wireless communications at a first UE, the code comprising instructions executable by a processor to perform a method of any of aspects 26 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
transmitting a sidelink control information message indicating a reserved resource for an upcoming sidelink transmission;
calculating a sidelink feedback channel resource of a sidelink feedback channel for a collision indication for the reserved resource based at least in part on a time domain parameter of a resource mapping between time domain resources of the sidelink feedback channel and time domain resources of the reserved resource; and
monitoring the sidelink feedback channel resource for the collision indication.

2. The method of claim 1, wherein calculating the sidelink feedback channel resource comprises:
calculating the sidelink feedback channel resource based at least in part on a time domain resource indexing scheme of the resource mapping, wherein the time domain resource indexing scheme begins at a first time domain resource corresponding to the sidelink feedback channel resource and increments up to a second time domain resource corresponding to the reserved resource.

3. The method of claim 1, wherein calculating the sidelink feedback channel resource comprises:
calculating the sidelink feedback channel resource based at least in part on a time domain resource indexing scheme of the resource mapping, wherein the time domain resource indexing scheme begins at a first time domain resource corresponding to the reserved resource and increments up to a second time domain resource corresponding to the sidelink feedback channel resource.

4. The method of claim 1, wherein calculating the sidelink feedback channel resource comprises:
calculating the sidelink feedback channel resource based at least in part on a frequency domain parameter of a second resource mapping between frequency domain resources of the sidelink feedback channel and frequency domain resources of the sidelink control information message.

5. The method of claim 4, wherein calculating the sidelink feedback channel resource comprises:
calculating a resource block index, wherein the sidelink feedback channel resource comprises a resource block associated with the resource block index.

6. The method of claim 1, further comprising:
receiving an indication of the collision indication in the sidelink feedback channel resource; and
transmitting the upcoming sidelink transmission using a communications resource different from the reserved resource based at least in part on the collision indication.

7. The method of claim 1, further comprising:
transmitting the upcoming sidelink transmission using the reserved resource based at least in part on the monitoring the sidelink feedback channel resource.

8. The method of claim 1, wherein calculating the sidelink feedback channel resource comprises:
calculating a first slot, wherein the sidelink feedback channel resource comprises the first slot and the reserved resource comprises a second slot.

9. The method of claim 8, wherein the first slot precedes the second slot.

10. The method of claim 1, wherein the sidelink feedback channel resource comprises a physical sidelink feedback channel (PSFCH).

11. A method for wireless communications at a first user equipment (UE), comprising:
receiving, from a second UE, a sidelink control information message indicating a reserved resource for a first upcoming sidelink transmission;
identifying a collision in the reserved resource;
calculating a sidelink feedback channel resource of a sidelink feedback channel for a collision indication for the reserved resource based at least in part on a time domain parameter of a resource mapping between time domain resources of the sidelink feedback channel and time domain resources of the reserved resource; and
transmitting the collision indication in the sidelink feedback channel resource.

12. The method of claim 11, wherein calculating the sidelink feedback channel resource comprises:
calculating the sidelink feedback channel resource based at least in part on a time domain resource indexing scheme of the resource mapping, wherein the time domain resource indexing scheme begins at a first time domain resource corresponding to the sidelink feedback channel resource and increments up to a second time domain resource corresponding to the reserved resource.

13. The method of claim 11, wherein calculating the sidelink feedback channel resource comprises:
calculating the sidelink feedback channel resource based at least in part on a time domain resource indexing scheme of the resource mapping, wherein the time domain resource indexing scheme begins at a first time domain resource corresponding to the reserved resource and increments up to a second time domain resource corresponding to the sidelink feedback channel resource.

14. The method of claim 11, wherein calculating the sidelink feedback channel resource comprises:
calculating the sidelink feedback channel resource based at least in part on a frequency domain parameter of a second resource mapping between frequency domain resources of the sidelink feedback channel and frequency domain resources of the sidelink control information message.

15. The method of claim 14, wherein calculating the sidelink feedback channel resource comprises:
calculating a resource block index, wherein the sidelink feedback channel resource comprises a resource block associated with the resource block index.

16. The method of claim 11, wherein calculating the sidelink feedback channel resource comprises:
calculating a first slot, wherein the sidelink feedback channel resource comprises the first slot and the reserved resource comprises a second slot.

17. The method of claim 16, wherein the first slot precedes the second slot.

18. The method of claim 11, wherein the sidelink feedback channel resource comprises a physical sidelink feedback channel (PSFCH).

19. The method of claim 11, further comprising:
receiving, from a third UE, a second sidelink control information message indicating the reserved resource for a second upcoming sidelink transmission, wherein the identifying the collision in the reserved resource is based at least in part on the sidelink control information message and the second sidelink control information message.

20. A method for wireless communications at a user equipment (UE), comprising:
transmitting a sidelink control information message indicating a reserved resource for an upcoming sidelink transmission;
calculating a sidelink feedback channel resource of a sidelink feedback channel for a collision indication for the reserved resource based at least in part on a frequency domain parameter of a resource mapping between frequency domain resources of the sidelink feedback channel and frequency domain resources of the sidelink control information message; and
monitoring the sidelink feedback channel resource for the collision indication.

21. The method of claim 20, wherein calculating the sidelink feedback channel resource comprises:
calculating a resource block index, wherein the sidelink feedback channel resource comprises a resource block associated with the resource block index.

22. The method of claim 21, wherein the sidelink control information message comprises the resource block.

23. The method of claim 20, wherein calculating the sidelink feedback channel resource comprises:
calculating the sidelink feedback channel resource based at least in part on a time domain parameter of a second resource mapping between time domain resources of the sidelink feedback channel and time domain resources of the reserved resource.

24. The method of claim 20, further comprising:
receiving an indication of the collision indication in the sidelink feedback channel resource; and
transmitting the upcoming sidelink transmission using a communications resource different from the reserved resource based at least in part on the collision indication.

25. The method of claim 20, further comprising:
transmitting the upcoming sidelink transmission using the reserved resource based at least in part on the monitoring the sidelink feedback channel resource.

26. A method for wireless communications at a first user equipment (UE), comprising:
receiving, from a second UE, a sidelink control information message indicating a reserved resource for a first upcoming sidelink transmission;
identifying a collision in the reserved resource;
calculating a sidelink feedback channel resource of a sidelink feedback channel for a collision indication for the reserved resource based at least in part on a frequency domain parameter of a resource mapping between frequency domain resources of the sidelink feedback channel and frequency domain resources of the sidelink control information message; and
transmitting the collision indication in the sidelink feedback channel resource.

27. The method of claim 26, wherein calculating the sidelink feedback channel resource comprises:
calculating a resource block index, wherein the sidelink feedback channel resource comprises a resource block associated with the resource block index.

28. The method of claim 27, wherein the sidelink control information message comprises the resource block.

29. The method of claim 26, wherein calculating the sidelink feedback channel resource comprises:
calculating the sidelink feedback channel resource based at least in part on a time domain parameter of a second resource mapping between time domain resources of the sidelink feedback channel and time domain resources of the reserved resource.

30. The method of claim 26, further comprising:
receiving, from a third UE, a second sidelink control information message indicating the reserved resource for a second upcoming sidelink transmission, wherein the identifying the collision in the reserved resource is based at least in part on the sidelink control information message and the second sidelink control information message.
